(19) United States
(12) Patent Application Publication
(10) Pub. No.: US 2013/0086531 A1
(43) Pub. Date: Apr. 4, 2013

(54) COMMAND ISSUING DEVICE, METHOD AND COMPUTER PROGRAM PRODUCT

(71) Applicants: Kaoru Sugita, Saitama (JP); Isao Mihara, Tokyo (JP); Daisuke Hirakawa, Saitama (JP)

(72) Inventors: Kaoru Sugita, Saitama (JP); Isao Mihara, Tokyo (JP); Daisuke Hirakawa, Saitama (JP)

(73) Assignee: KABUSHIKI KAISHA TOSHIBA, Tokyo (JP)

(21) Appl. No.: 13/486,295

(22) Filed: Jun. 1, 2012

(30) Foreign Application Priority Data
Sep. 29, 2011 (JP) 2011-213998

(51) Int. Cl. G06F 3/033

(52) U.S. Cl. 715/863

(57) ABSTRACT

According to an embodiment, a command issuing device includes an acquiring unit configured to acquire a moving image by capturing a hand of an operator; a projection area recognizer configured to recognize a projection area of a projection finger in the moving image; a projector configured to project one of pictures of a graphical user interface (GUI) onto the projection area; an operation area recognizer configured to recognize an operation area of an operation finger in the moving image; a selection determining unit configured to measure an overlapping degree of the projection area and the operation area to determine whether or not the GUI is selected; and a issuing unit configured to issue a command associated with the GUI when it is determined that the GUI is selected.

### CROSS-REFERENCE TO RELATED APPLICATION(S)

This application is based upon and claims the benefit of priority from Japanese Patent Application No. 2011-213998, filed on Sep. 29, 2011; the entire contents of which are incorporated herein by reference.

### FIELD

Embodiments described herein relate generally to a command issuing device, a method therefor and a computer program product.

### BACKGROUND

User interfaces that realize user operation by combining picture projection techniques, imaging techniques, object recognition techniques and the like are conventionally known. For example, some of such user interfaces realize user operation by projecting a picture of a graphical user interface (GUI) on the palm of one hand of an operator, capturing a moving image of the palm, and recognizing that the operator is touching the GUI projected on the palm with a finger of the other hand on the basis of the captured moving image.

Such techniques as described above, however, are based on the operation using both hands of the operator.

### BRIEF DESCRIPTION OF THE DRAWINGS

FIG. 1 is an outline view illustrating an exemplary use of a command issuing device according to a first embodiment;

FIG. 2 is a configuration diagram illustrating an exemplary command issuing device according to the first embodiment;

FIG. 3 is a diagram illustrating an example of a moving image acquired by an acquiring unit according to the first embodiment;

FIG. 4 is a diagram illustrating an example of an image resulting from extracting projection fingers from the moving image according to the first embodiment;

FIG. 5 is a diagram illustrating an example of an image resulting from extracting an operation finger from the moving image according to the first embodiment;

FIG. 6A is a diagram illustrating an example of GUI information of according to the first embodiment;

FIG. 6B is a diagram illustrating an example of GUI information according to the first embodiment;

FIG. 7A is a diagram illustrating an example of GUI information according to the first embodiment;

FIG. 7B is a diagram illustrating an example of GUI information according to the first embodiment;

FIG. 7C is a diagram illustrating an example of GUI information according to the first embodiment;

FIG. 8A is a diagram illustrating an example of GUI information according to the first embodiment;

FIG. 8B is a diagram illustrating an example of GUI information according to the first embodiment;

FIG. 9 is an explanatory diagram illustrating an example of a projecting technique for a projector according to the first embodiment;

FIG. 10 is an explanatory diagram of an example of a technique for recognizing an operation area according to the first embodiment;

FIG. 11 is a flowchart illustrating an example of processes according to the first embodiment;

FIG. 12 is a diagram illustrating an example of a moving image acquired by the acquiring unit according to the first embodiment;

FIG. 13 is an explanatory diagram illustrating an example of a technique for extracting prior feature values of projection fingers according to the first embodiment;

FIG. 14 is a flowchart illustrating an example of a projection area recognition process according to the first embodiment;

FIG. 15 is an explanatory diagram of an example of a technique for recognizing projection areas according to the first embodiment;

FIG. 16 is an explanatory diagram of an example of the technique for recognizing projection areas according to the first embodiment;

FIG. 17 is an explanatory diagram of an example of the technique for recognizing projection areas according to the first embodiment;

FIG. 18 is an explanatory diagram of an example of the technique for recognizing projection areas according to the first embodiment;

FIG. 19 is a flowchart illustrating an example of a projection process according to the first embodiment;

FIG. 20 is a flowchart illustrating an example of a selection determination process according to the first embodiment;

FIG. 21 is a configuration diagram illustrating an exemplary command issuing device according to a modified example 1;

FIG. 22 is a configuration diagram illustrating an exemplary command issuing device according to a modified example 2;

FIG. 23 is an explanatory diagram illustrating an example of a dividing technique for a dividing unit according to the modified example 2;

FIG. 24 is a configuration diagram illustrating an exemplary command issuing device according to a second embodiment;

FIG. 25 is an explanatory diagram illustrating a technique for recognizing a palm area for a palm area recognizer according to the second embodiment;

FIG. 26A is a diagram illustrating an example of GUI information according to the second embodiment;

FIG. 26B is a diagram illustrating an example of GUI information according to the second embodiment;

FIG. 26C is a diagram illustrating an example of GUI information according to the second embodiment;

FIG. 26D is a diagram illustrating an example of GUI information according to the second embodiment;

FIG. 27A is a diagram illustrating an example of switching of the GUIs according to the second embodiment;

FIG. 27B is a diagram illustrating an example of switching of the GUIs according to the second embodiment;

FIG. 28 is a configuration diagram illustrating an exemplary command issuing device according to a modified example 5;

FIG. 29A is a diagram illustrating an example of switching of GUIs according to the modified example 5;

FIG. 29B is a diagram illustrating an example of switching of the GUIs according to the modified example 5;

FIG. 30 is a configuration diagram illustrating an exemplary command issuing device according to a modified example 6;

FIG. 31A is a diagram illustrating an example of switching of GUIs according to the modified example 6;

FIG. 31B is a diagram illustrating an example of switching of the GUIs according to the modified example 6;

FIG. 32 is a configuration diagram illustrating an exemplary command issuing device according to a modified example 7;

FIG. 33A is a diagram illustrating an example of switching of GUIs according to the modified example 7;

FIG. 33B is a diagram illustrating an example of switching of the GUIs according to the modified example 7;

FIG. 34 is a configuration diagram illustrating an exemplary command issuing device according to a third embodiment;

FIG. 35 is a diagram illustrating an example of projection of a feedback picture according to the third embodiment;

FIG. 36 is a diagram illustrating an example of projection of a feedback picture according to the third embodiment;

FIG. 37 is a diagram illustrating an example of projection of a feedback picture according to the third embodiment;

FIG. 38 is an explanatory diagram illustrating a technique for projecting a feedback picture according to the third embodiment;

FIG. 39 is a configuration diagram illustrating an exemplary command issuing device according to a fourth embodiment;

FIG. 40 is an outline view illustrating an exemplary use of a command issuing device according to a fifth embodiment;

FIG. 41 is a diagram illustrating an example of a moving image acquired by an acquiring unit and a presentation technique according to the fifth embodiment;

FIG. 42 is a configuration diagram illustrating an exemplary command issuing device according to the fifth embodiment; and

FIG. 43 is an explanatory diagram of a presentation technique according to the fifth embodiment.

### DETAILED DESCRIPTION

According to an embodiment, a command issuing device includes an acquiring unit configured to acquire a moving image by capturing a hand of an operator; a projection area recognizer configured to recognize a projection area of a projection finger in the moving image, the projection finger being one of fingers onto which one of pictures of a graphical user interface (GUI) is projected; a projector configured to project one of the pictures of the GUI onto the projection area; an operation area recognizer configured to recognize an operation area of an operation finger in the moving image, the operation finger being one of fingers which is assigned to operate the GUI; a selection determining unit configured to measure an overlapping degree of the projection area and the operation area to determine whether or not the GUI is selected; and a issuing unit configured to issue a command associated with the GUI when it is determined that the GUI is selected.

### First Embodiment

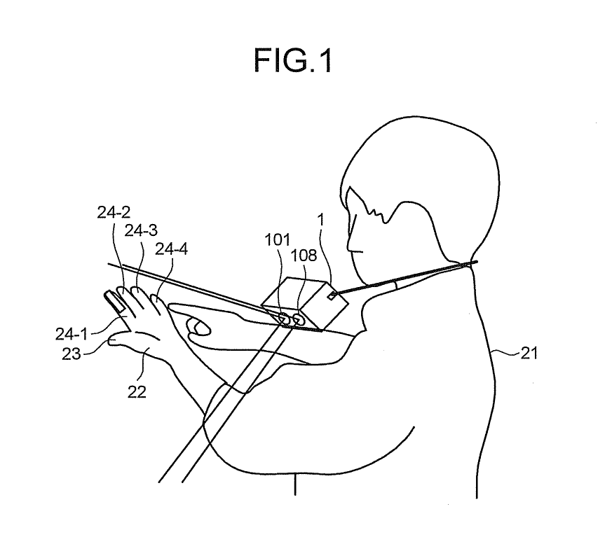

FIG. 1 is an outline view illustrating an example of use of a command issuing device 1 according to a first embodiment. In this embodiment, a pendant type use in which an operator 21 wear a strap or the like attached to the command issuing device 1 around his/her neck so that the command issuing device 1 is positioned in front of the chest of the operator 21 is assumed as illustrated in FIG. 1. An acquiring unit 101 of the command issuing device 1 is arranged such that the acquiring unit 101 can capture a moving image of a hand 22 of the operator 21, and a projector 108 of the command issuing device 1 is arranged such that the projector 108 can project a picture of a graphical user interface (GUI) onto the hand 22. Accordingly, a moving picture of the hand 22 is captured by the acquiring unit 101 and a picture of the GUI is projected onto the hand 22 by the projector 108.

Note that, a thumb 23 of the hand 22 is an operation finger used for operation and an index finger 24-1, a middle finger 24-2, a third finger 24-3 and a little finger 24-4 of the hand 22 are projection fingers used for projection of GUI pictures in this embodiment, but the allocation to fingers is not limited thereto. In the example illustrated in FIG. 1, a GUI picture is projected on the index finger 24-1. When the operator 21 views the GUI picture projected on the index finger 24-1 and puts the thumb 23 over the GUI picture on the index finger 24-1, the command issuing device 1 issues a command associated with the GUI. As a result, user operation indicated by the GUI is performed. Note that the index finger 24-1, the middle finger 24-2, the third finger 24-3 and the little finger 24-4 may be hereinafter referred to as fingers 24 other than the thumb when these fingers need not be distinguished from one another.

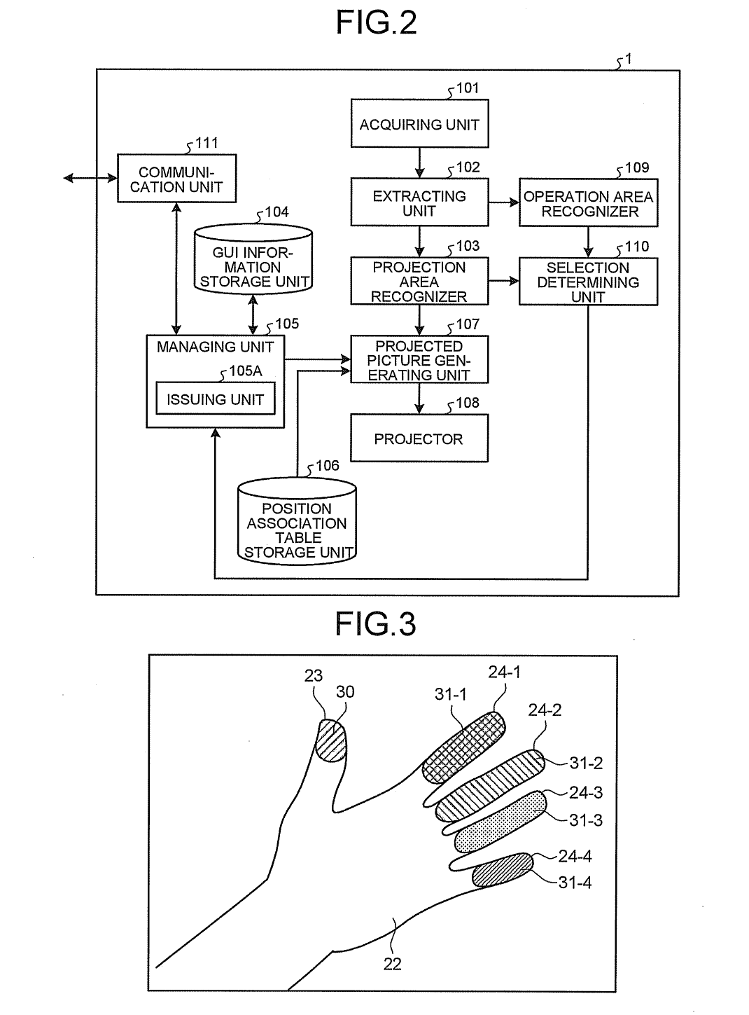

FIG. 2 is a configuration diagram illustrating an example of the command issuing device 1 according to the first embodiment. As illustrated in FIG. 2, the command issuing device 1 includes the acquiring unit 101, an extracting unit 102, a projection area recognizer 103, a GUI information storage unit 104, a managing unit 105, a position association table storage unit 106, a projected picture generating unit 107, the projector 108, an operation area recognizer 109, a selection determining unit 110 and a communication unit 111.

The acquiring unit 101 acquires a moving image obtained by capturing a hand of an operator. The acquiring unit 101 may be any device capable of capturing a moving image. Although it is assumed in this embodiment that the acquiring unit 101 is realized by a video camera, the acquiring unit 101 is not limited thereto. In this embodiment, the acquiring unit 101 can capture moving images in color at 60 frames per second, and has a sufficient angle of view for capturing the hand 22, a mechanism capable of automatically adjusting the focal length, and a distortion correction function for correcting a distortion caused in a captured image because of a lens.

It is assumed in this embodiment that color markers are attached on a tip portion of the thumb 23 of the operator 21 and entire portions (portions from bases to tips) of the fingers 24 other than the thumb of the operator 21. It is assumed that the color markers are made of diffuse reflective materials that are not specular and each having a single color that can be distinguished from the surface of the hand. The color markers of the respective fingers have different colors from one another.

FIG. 3 is a diagram illustrating an example of a moving image acquired by the acquiring unit 101. FIG. 3 represents a moving image obtained by capturing the hand 22 of the operator 21 with a color marker 30 attached on the tip portion of the thumb 23, and color markers 31-1, 31-2, 31-3 and 31-4 attached on the index finger 24-1, the middle finger 24-2, the third finger 24-3 and the little finger 24-4, respectively.

The extracting unit 102 performs image processing on the moving image acquired by the acquiring unit 101 to extract the projection fingers and the operation finger. Specifically, the extracting unit 102 applies a color filter on the moving image acquired by the acquiring unit 101 to assign nonzero values only to pixels with colors within a specific hue range and “0” to pixels with other colors and thereby extracts the projection fingers and the operation finger. It is assumed here that the colors of the color markers attached on the respective fingers of the operator 21 are known and that the extracting unit 102 holds in advance luminance distribution of the color markers in the moving image acquired by the acquiring unit 101.

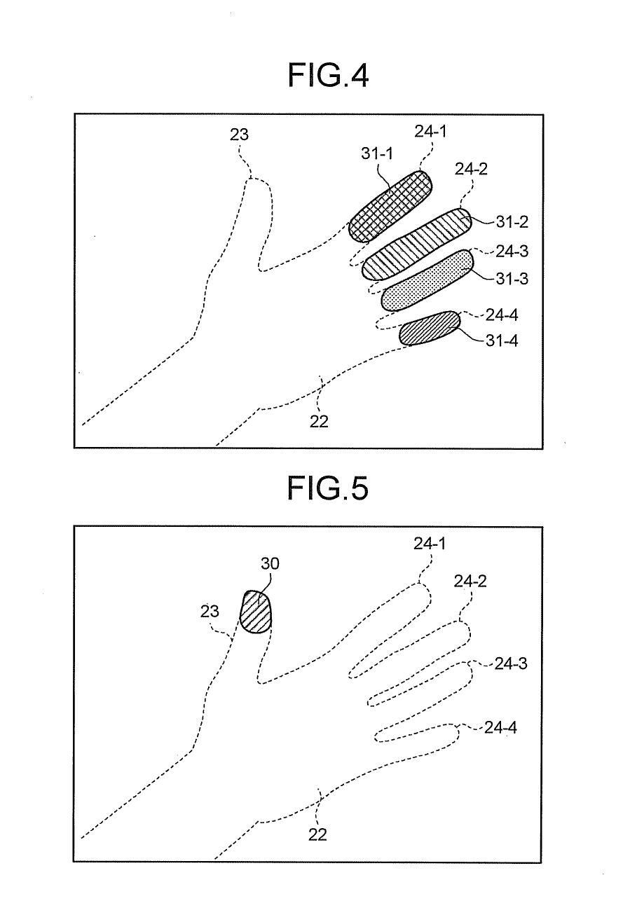

FIG. 4 is a diagram illustrating an example of an image (bitmapped image) resulting from extracting the fingers 24 (color markers 31-1 to 31-4) other than the thumb that are projection fingers from the moving image acquired by the acquiring unit 101. FIG. 5 is a diagram illustrating an example of an image (bitmapped image) resulting from extracting the thumb 23 (color marker 30) that is an operation finger from the moving image acquired by the acquiring unit 101.

As described above, the technique of extracting the operation finger and the projection fingers by attaching the color markers on the respective fingers of the operator 21 is described in this embodiment, but the technique for extracting the operation finger and the projection fingers is not limited thereto. For example, the operation finger and the projection fingers may be extracted by measuring distance distribution from the command issuing device 1 to the hand 22 of the operator 21 using a range finder or the like employing a laser ranging system and applying known shape information of the hand such as the length and the thickness of the fingers. For measuring the distance distribution from the command issuing device 1 to the hand 22 of the operator 21, a technique such as stereo matching using a plurality of cameras can be used. Moreover, if finger areas are detected by using a detector for image recognition based on Haar-Like features to extract the operation finger and the projection fingers, for example, the color markers need not be attached on the respective fingers of the operator 21.

The projection area recognizer 103 recognizes projection areas of the projection fingers from the moving image acquired by the acquiring unit 101. Specifically, the projection area recognizer 103 extracts shape feature values from the bases to the tips of the projection fingers from the image of the projection fingers extracted by the extracting unit 102, and recognizes areas represented by the extracted shape feature values as projection areas. Details of the technique for recognizing the projection areas will be described later.

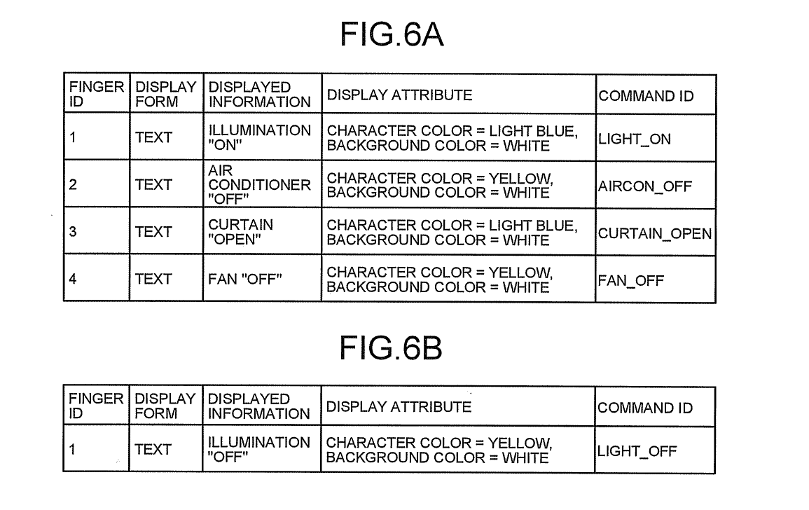

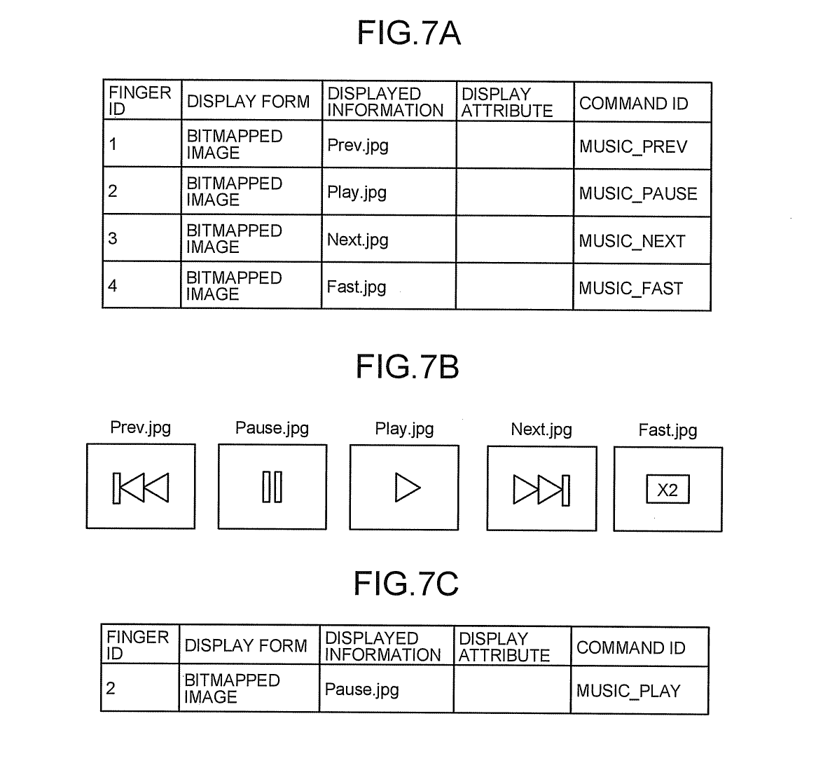

The GUI information storage unit 104 stores therein information on the GUIs projected on the projection areas of the projection fingers. FIGS. 6A and 6B are diagrams illustrating an example of the GUI information in a case where the command issuing device 1 is a user interface configured to issue commands for controlling home devices. FIGS. 7A to 7C are diagrams illustrating an example of the GUI information in a case where the command issuing device 1 is a user interface configured to issue commands for controlling a music player.

The GUI information is in a form of a table associating a finger ID, a display form, displayed information, a display attribute and a command ID. The “finger ID” is an index for identifying the projection fingers. For example, a finger ID “1” represents the index finger 24-1, a finger ID “2” represents the middle finger 24-2, a finger ID “3” represents the third finger 24-3, and a finger ID “4” represents the little finger 24-4. Note that information in the case where the finger ID is “2” to “4” is omitted in the examples illustrated in FIGS. 6B and 7C. The “display form” represents a display form of the GUI on the projection finger represented by the finger ID, and is in a form of a text in the examples illustrated in FIGS. 6A and 6B and in a form of a bitmapped image in the examples illustrated in FIGS. 7A and 7C. The “displayed information” represents displayed GUI information on the projection finger represented by the finger ID, and a text to be displayed is set thereto in the examples illustrated in FIGS. 6A and 6B and an image file to be displayed is set thereto in the examples illustrated in FIGS. 7A and 7C. The image files to be displayed are as illustrated in FIG. 7B. The “display attribute” represents a displayed color of the GUI on the projection finger represented by the finger ID. In the examples illustrated in FIGS. 7A and 7C, however, the display attribute is not set because the GUI is an image. The “command ID” represents a command issued when the GUI projected on the projection finger represented by the finger ID is selected.

Although an example in which the GUI information associates a projection finger uniquely with a GUI element is described in this embodiment, the association is not limited thereto. For example, the number of GUI elements may be smaller than the number of the projection fingers depending on the information projected by the command issuing device 1 or the device to be controlled by the command issuing device 1. In addition, even if the number of the GUI elements is equal to the number of the projection fingers, only some of the projection fingers may be recognized because of fingers obscured by one another. The GUI information may therefore not associate a projection finger uniquely with a GUI element.

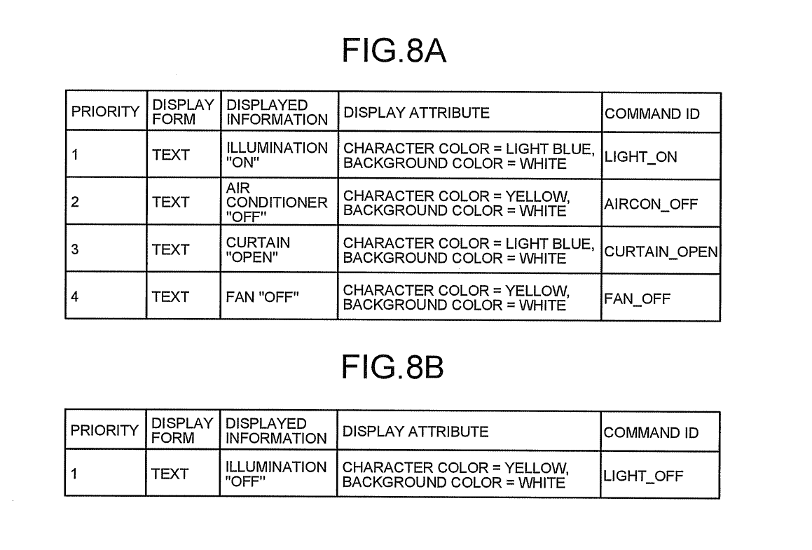

FIGS. 8A and 8B are diagrams illustrating examples of the GUI information that does not associate a projection finger uniquely with a GUI element. In the GUI information illustrated in FIGS. 8A and 8B, priority is set in place of the finger ID. It is assumed here that the priority is higher as the numerical value of the priority is smaller.

The managing unit 105 manages the GUI projected on projection areas and commands issued when the GUI is selected. The managing unit 105 includes an issuing unit 105A. Details of the issuing unit 105A will be described later.

In the case of the GUI information illustrated in FIG. 6A, for example, the managing unit 105 assigns a text “ILLUMINATION “ON”” to the projection area of the index finger 24-1 and sets the display color of the text to light blue and the background color to white. “ILLUMINATION “ON”” indicates that the illumination is to be turned on.

In the case of the GUI information illustrated in FIG. 6B, for example, the managing unit 105 assigns a text “ILLUMINATION “OFF”” to the projection area of the index finger 24-1 and sets the display color of the text to yellow and the background color to white. “ILLUMINATION “OFF”” indicates that the illumination is to be turned off.

In the case of the GUI information illustrated in FIG. 7A, for example, the managing unit 105 assigns an icon image represented by “Play.jpg” to the projection area of the middle finger 24-2. “Play.jpg” indicates that audio is to be played.

In the case of the GUI information illustrated in FIG. 7C, for example, the managing unit 105 assigns an icon image represented by “Pause.jpg” to the projection area of the middle finger 24-2. “Pause.jpg” indicates that audio is to be paused.

In the case of the GUI information illustrated in FIG. 8A or 8B, for example, the managing unit 105 further sets priority separately for the projection fingers. For example, when the operation finger is the thumb 23 and the projection fingers are the fingers 24 other than the thumb as in this embodiment, the bending amount of the thumb 23 for selecting the GUI is smaller and thus the selecting operation is easier as the fingers 24 other than the thumb are closer to the thumb 23 according to the physical characteristics. In this case, the managing unit 105 sets higher priority to the index finger 24-1 followed by the middle finger 24-2, the third finger 24-3 and the little finger 24-4. Specifically, the managing unit 105 calculates in advance the distance between the center position of the color marker 30 of the operation finger and the base position of each of the projection fingers, and sets higher priority as the calculated distance is shorter. The base positions of the respective projection fingers are calculated by the projection area recognizer 103 and the center position of the color marker 30 of the operation finger is calculated by the operation area recognizer 109. The managing unit 105 then assigns GUIs in descending order of the priority out of unassigned GUIs illustrated in FIGS. 8A and 8B to projection fingers in descending order of the priority. In this manner, it is possible to assign GUIs with high priority to projection fingers for which the selecting operation is easier.

The position association table storage unit 106 stores therein a position association table associating a coordinate position on an imaging plane of the moving image acquired by the acquiring unit 101 with a coordinate position on a projection plane of the projector 108. When the capturing angle of view and the optical axis of the acquiring unit 101 are not coincident with the projection angle of view and the optical axis of the projector 108, the capturing range of the acquiring unit 101 and the projecting range of the projector 108 are not coincident with each other. Accordingly, the position association table storage unit 106 holds association of positions between the imaging plane of the acquiring unit 101 and the projection plane of the projector 108 as described above.

In this embodiment, the projector 108 projects a pattern to a predetermined position expressed by two-dimensional coordinates on the projection plane, the acquiring unit 101 images the pattern, and the position on the projection plane and the position on the imaging plane are associated to obtain the position association table.

In this embodiment, the position association table is used for a process of transforming the shape of a projected picture performed by the projected picture generating unit 107. When the projected picture generating unit 107 uses perspective projection-based transformation for the process for transforming the shape of a projected picture, the position association table has only to prepare at least four associations and holds a position on the imaging plane and a position on the projection plane for each point. Details of these processes will not be described because techniques known in the field of computer vision can be used therefor and these processes can be performed using instructions called cvGetPerspective Transform and cvWarpPerspective included in a commonly-available software library OpenCV, for example.

The projected picture generating unit 107 generates a projected picture to be projected onto a projection area recognized by the projection area recognizer 103 according to the GUI information set by the managing unit 105. Specifically, the projected picture generating unit 107 generates a picture according to the GUI information set by the managing unit 105 for each projection finger and transforms the generated picture according to the position association table to generate a projected picture conforming to the projection area recognized by the projection area recognizer 103. Accordingly, the projector 108 can project a projected picture conforming to the projection area. The projected picture generating unit 107 can be realized by a graphics processor.

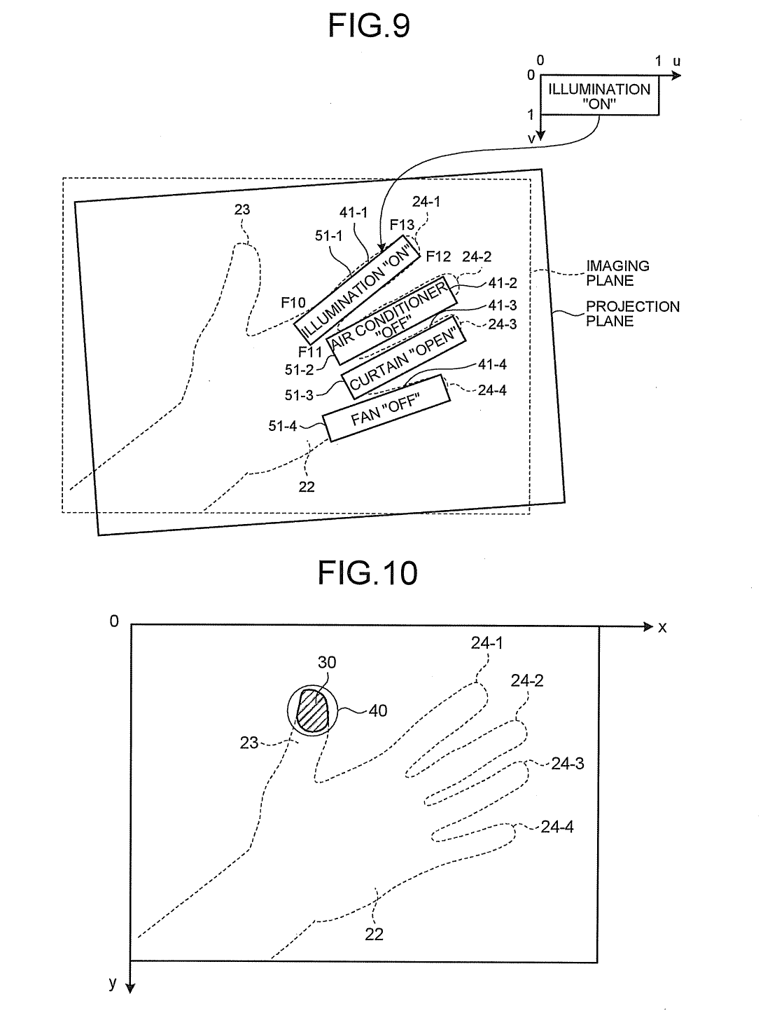

The projector 108 projects a GUI picture onto the projection area recognized by the projection area recognizer 103. Specifically, the projector 108 projects projected GUI pictures 51-1 to 51-4 generated by the projected picture generating unit 107 onto projection areas 41-1 to 41-4, respectively, of projection fingers recognized by the projection area recognizer 103 as illustrated in FIG. 9. The projection area 41-1 of the index finger 24-1 is a rectangle F10F11F12F13. The projector 108 is realized by a projector in this embodiment, but the projector 108 is not limited thereto. Note that the projector needs to be focused on projection onto the hand 22 so that the operator 21 can view the picture on the hand 22. This may be realized by using a laser projector that is always in focus or by using a mechanism for automatically adjusting the focal length included in a projector. In addition, the projected pictures need to have sufficiently high projection luminance and colors that are not concealed by the colors of the color markers and the palm surface. The luminance and colors may be adjusted in advance. In addition, the distortion correction or the like of the projection plane by the projector is performed in advance. The projector 108 may start projecting light when a projection area is recognized by the projection area recognizer 103 and stop projecting light when the projection area is no longer recognized by the projection area recognizer 103 instead of always projecting a light source of the projector.

The operation area recognizer 109 recognizes an operation area of the operation finger from a moving image acquired by the acquiring unit 101. Specifically, the operation area recognizer 109 extracts the shape feature value of the tip of the operation finger from the image of the operation finger extracted by the extracting unit 102, and recognizes an area represented by the extracted feature value as the operation area.

FIG. 10 is an explanatory diagram of an example of a technique for recognizing the operation area. The operation area recognizer 109 approximates the area of the color marker 30 extracted by the extracting unit 102 as a circle 40 and calculates the center position and the radius of the circle 40 to recognize the operation area. Specifically, the operation area recognizer 109 obtains a median point of the area of the color marker 30, sets the center position of the circle 40 to the median point, divides the number of pixels that is an area of the area of the color marker 30 by n, extracts the square root of the division result, and sets the radius of the circle 40 to the square root.

An index for the operation area recognized by the operation area recognizer 109 may be obtained by using a method of approximating the tip area of the thumb 23 as an elliptical shape having the center position, the diameter direction and length and the length of a rectangle that crosses the diameter at right angle, a method of approximating the area as a rectangle, or a method of approximating the area as an area within a contour including a plurality of connected lines, in addition to the method of approximating the area as a circle as described above.

The selection determining unit 110 measures the overlapping degree of the projection area recognized by the projection area recognizer 103 and the operation area recognized by the operation area recognizer 109, and determines whether or not the GUI projected on the projection area is selected.

Here, the issuing unit 105A will be described. When it is determined by the selection determining unit 110 that the GUI is selected, the issuing unit 105A issues a command associated with the GUI.

For example, it is assumed that the GUI information illustrated in FIG. 6A is used, that a picture of the GUI “ILLUMINATION “ON”” is projected on the projection area of the index finger 24-1 and that it is determined that the GUI projected on the projection area of the index finger 24-1 is selected. In this case, the issuing unit 105A issues a command “LIGHT_ON”.

As another example, it is assumed that the GUI information illustrated in FIG. 6B is used, that a picture of the GUI “ILLUMINATION “OFF”” is projected on the projection area of the index finger 24-1 and that it is determined that the GUI projected on the projection area of the index finger 24-1 is selected. In this case, the issuing unit 105A issues a command “LIGHT_OFF”.

The communication unit 111 transmits the command issued by the issuing unit 105A to an external device to be controlled. Upon receiving a notification of a change in the GUI information from the external device to be controlled to which the communication unit 111 transmitted a command as a result of transmitting the command, the communication unit 111 informs the managing unit 105 of the same. Then, the managing unit 105 switches to the GUI information to be used among the GUI information stored in the GUI information storage unit 104. For example, when the GUI information illustrated in FIG. 6A is used and the issuing unit 105A issued the command “LIGHT_ON”, the managing unit 105 receives the notification of the change from the external device to be controlled and switches to the GUI information illustrated in FIG. 6B.

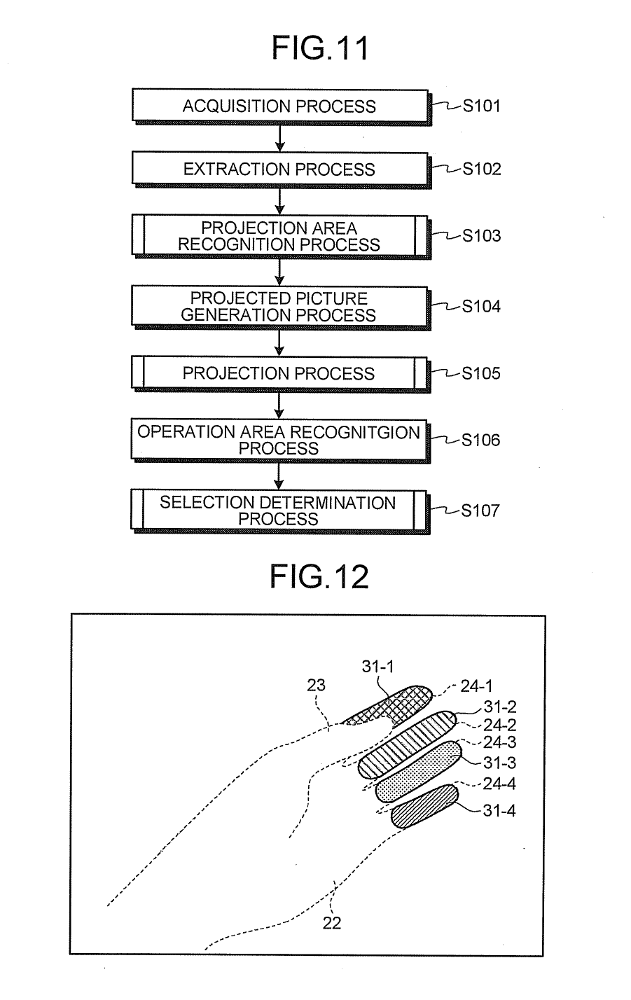

FIG. 11 is a flowchart illustrating an example of processes performed by the command issuing device 1 according to the first embodiment. The process flow illustrated in FIG. 11 is performed 30 times or 60 times per second, for example. The determination of the selecting operation of the GUI by the operator 21 is immediately made, and even if a projection finger of the operator 21 is moved, the projected picture projected on the projection finger immediately follows the projection finger.

First, the acquiring unit 101 performs an acquisition process of acquiring a moving image obtained by capturing a hand of an operator (step S101).

Subsequently, the extracting unit 102 performs an extraction process of performing image processing on the moving image acquired by the acquiring unit 101 to extract projection fingers and an operation finger (step S102).

Subsequently, the projection area recognizer 103 performs a projection area recognition process of recognizing projection areas of the projection fingers from the image of the projection fingers extracted by the extracting unit 102 (step S103).

Details of the projection area recognition process will be described here.

First, in this embodiment, since a GUI is selected by bringing the operation area of the operation finger over a GUI picture projected on a projection area of a projection finger, the color marker attached to the projection finger may be hidden by the operation finger in the picture of the projection finger extracted by the extracting unit 102 as illustrated in FIG. 12. In the example illustrated in FIG. 12, the color marker 31-1 attached to the index finger 24-1 is hidden by the thumb 23. When a color maker attached to a projection finger is hidden in this manner, the projection area recognizer 103 needs to estimate the hidden area of the color marker. The projection area recognizer 103 thus needs to extract, as a preprocess, prior feature values that are feature values of the projection fingers in a state where the color markers attached to the projection fingers are not hidden.

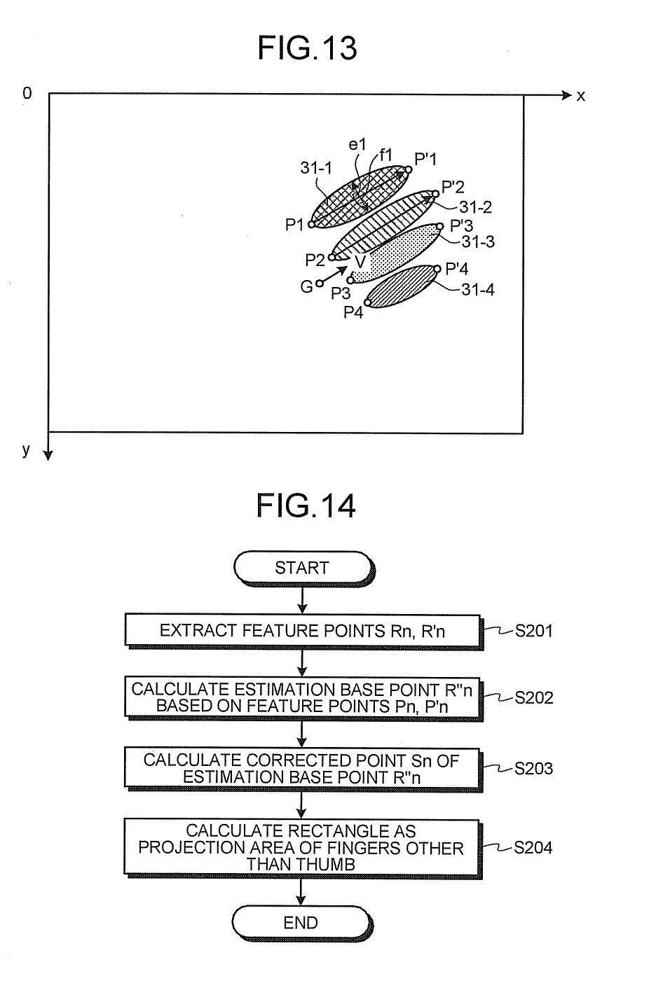

FIG. 13 is an explanatory diagram illustrating an example of a technique for extracting prior feature values of projection fingers according to the first embodiment. As illustrated in FIG. 13, the projection area recognizer 103 sets a coordinate system for an image in which the color markers attached to the projection fingers are not hidden extracted by the extracting unit 102. The coordinate system has the point of origin at an upper-left point of the image, the x-axis in the horizontal direction and the y-axis in the vertical direction.

Details of the projection area recognition process will be described here.

The projection area recognizer 103 determines the prior feature values of the projection fingers by using positions of tip points and base points of the color markers attached to the projection fingers. The projection area recognizer 103 sets IDs of the projection fingers to n (n=1 to 4). In this embodiment, the ID of the index finger 24-1 is n=1, the ID of the middle finger 24-2 is n=2, the ID of the third finger 24-3 is n=3, and the ID of the little finger 24-4 is n=4. The projection area recognizer 103 also sets the base points of the projection fingers to Pn and the tip points of the projection fingers to P′n. Specifically, the projection area recognizer 103 sets the coordinates of a pixel with the largest x-coordinate value to P′n and the coordinates of a pixel with the smallest x-coordinate value to Pn for each ID of the projection fingers.

The projection area recognizer 103 then obtains a median point G of P1 to P4 and an average directional vector V of directional vectors P1P′1 to P4P′4. The projection area recognizer 103 further searches for a pixel that is farthest from line a PnP′n in the direction of a line perpendicular to the directional vector PnP′n for each ID of the projection fingers, stores the distance between the pixel and the line PnP′n in the counterclockwise direction from the line PnP′n to feature values en and in the clockwise direction from the line PnP′n to feature values fn.

FIG. 14 is a flowchart illustrating an example of the projection area recognition process according to the first embodiment.

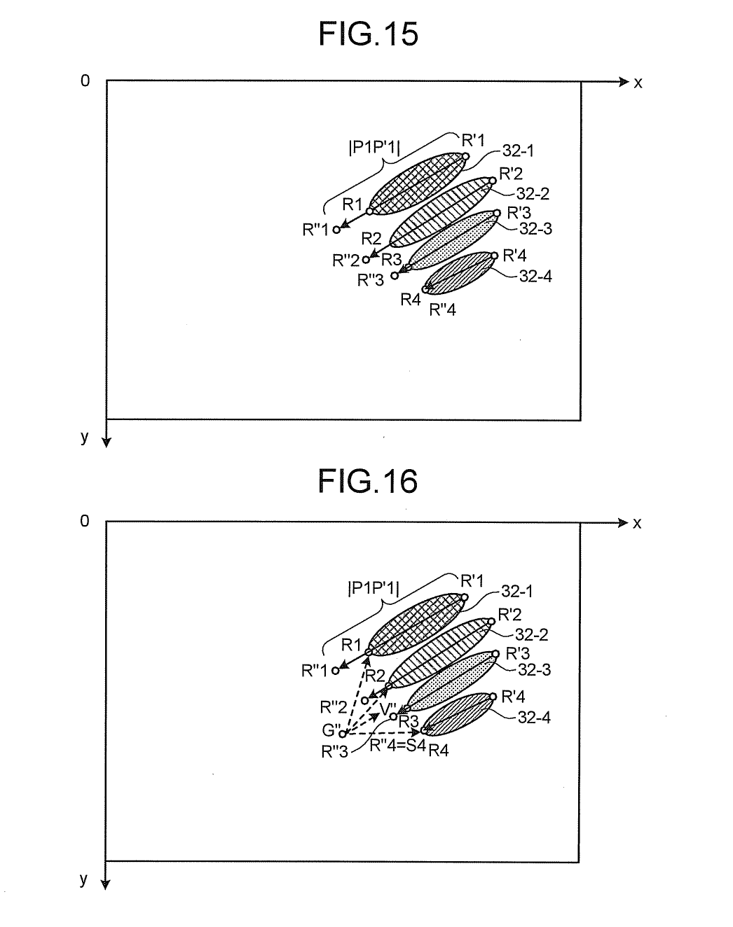

First, the projection area recognizer 103 extracts feature points Rn, R′n of the projection fingers (step S201). Specifically, the projection area recognizer 103 extracts base points Rn and tip points R′n of the areas 32-n of the color markers attached to the projection fingers as illustrated in FIG. 15. Since this process is similar to that for extracting the prior feature values, detailed description thereof will not be repeated.

Subsequently, the projection area recognizer 103 calculates estimated base points R″n taking hidden areas into consideration on the basis of the prior feature points Pn, P′n (step S202). Specifically, the projected area recognizer 103 sets points obtained by extending the lines PnP′n in the direction from R′n to Rn, where R′n is a reference point, to R″n as illustrated in FIG. 15.

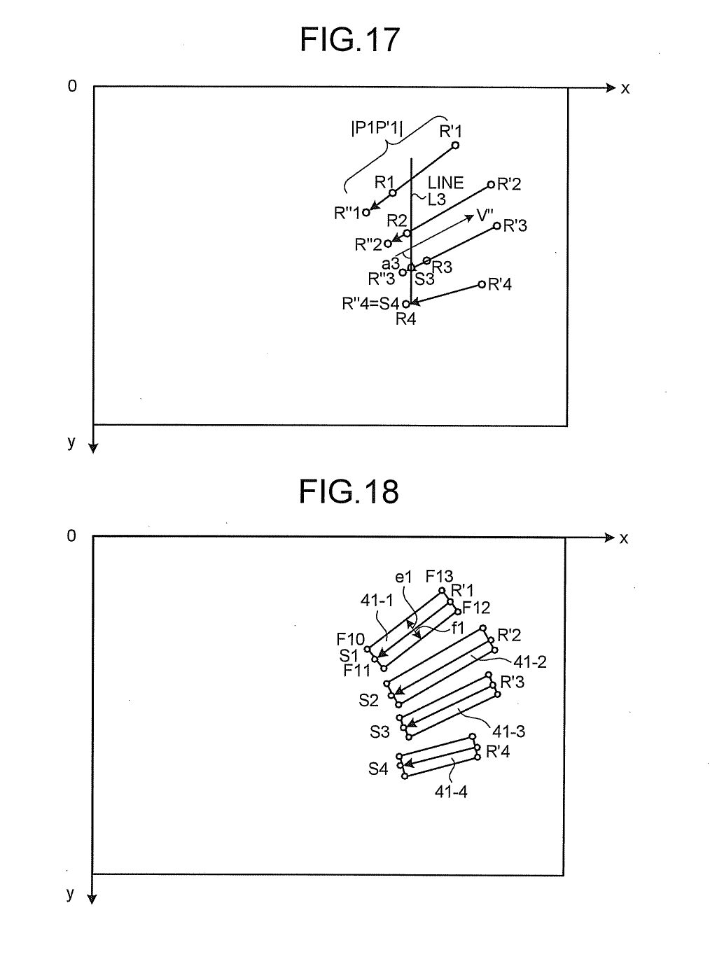

Subsequently, the projection area recognizer 103 calculates corrected points Sn of the estimated base points R″n (step S203). Specifically, the projection area recognizer 103 first obtains a median point G″ of R″1 to R″4 as illustrated in FIG. 16. The projection area recognizer 103 then obtains an average directional vector V″ of directional vectors R″1R′1 to R″4R′4. The projection area recognizer 103 then obtains a scalar product dn of each of directional vectors G″Rn and the directional vector V″, and sets an ID with the smallest dn to m. Here, m=4 is obtained. In addition, this m is set to satisfy Sm=R″m. The projection area recognizer 103 then obtains lines PmPn (n≠m) and angles an (n≠m) at which the lines PmPn each intersect with V for each of the projection fingers other than m. The projection area recognizer 103 then obtains intersections Sn (n=n other than m) of lines Ln (n≠m) passing through Sm and intersecting with the directional vector V″ at the angles an and lines R″nRn (n≠m) as illustrated in FIG. 17. In FIG. 17, a case where n=3 is illustrated. If the line R″nRn does not intersect with Ln for a certain n, the projection area recognizer 103 sets Sn to Sn=R″n.

Subsequently, the projection area recognizer 103 obtains points Fni (i=0 to 3) away from the end points Sn and R′n of the line SnR′n in the direction perpendicular thereto by the amounts of the feature values en and fn representing the thickness of the fingers calculated in advance for the respective IDs of the projection fingers as illustrated in FIG. 18. The projection area recognizer 103 then recognizes a rectangle Fn0Fn1Fn2Fn3 as a projection area for each ID of the projection fingers (step S204).

An index for a projection area may be obtained by using a method of approximating the projection area as an elliptical shape having the center position, the diameter direction and length and the length of a rectangle that crosses the diameter at right angle, a method of approximating the projection area as an area within a contour including a plurality of connected lines, in addition to the method of approximating the projection area as a rectangle as described above.

The description refers back to FIG. 11. Subsequently, the projected picture generating unit 107 performs a projected picture generation process of generating a picture according to the GUI information set by the managing unit 105 for each projection finger and transforming the generated picture according to the position association table to generate a projected picture conforming to the projection area recognized by the projection area recognizer 103 (step S104).

Subsequently, the projector 108 performs a projection process of projecting projected pictures generated by the projected picture generating unit 107 onto projection areas recognized by the projection area recognizer 103 (step S105).

Details of the projection process will be described here.

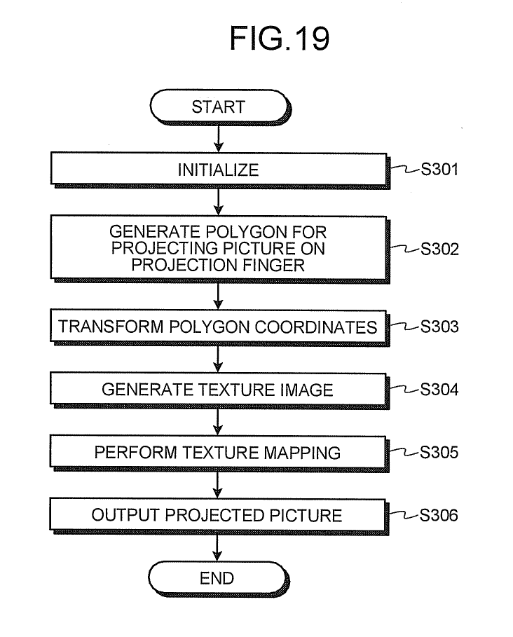

FIG. 19 is a flowchart illustrating an example of the projection process according to the first embodiment.

First, the projector 108 reserves areas into which projected pictures projected by itself are to be stored in a frame memory and initializes the areas (step S301). For example, the projector 108 initializes the entire areas with black because pictures are not projected onto areas displaying in black.

Subsequently, the projected picture generating unit 107 obtains information on the projection areas of the respective projection fingers input from the projection area recognizer 103, defines a polygon using coordinates of vertexes of the rectangle Fn0Fn1Fn2Fn3 that is a projection area for ID=n, and assigns texture coordinates (u, v) to the vertexes of the polygon (see FIG. 9; step S302).

Subsequently, the projected picture generating unit 107 performs a perspective projection-based transformation process using the information in the position association table storage unit 106 to transform the vertexes Fn0Fn1Fn2Fn3 of the polygon to F′n0F′n1F′n2F′n3 (step S303). This process can be realized by a vertex shader function of a graphics processor.

Subsequently, the projected picture generating unit 107 generates a texture image (GUI image) for the projection area of each projection finger (step S304). For example, a character string or an image may be drawn close to the tip end of the projection finger taking the physical characteristics that the base of a projection finger is more easily hidden than the tip thereof by the operation finger. For example, the character string or the image may be drawn on the right side when the left hand is used for operation.

Subsequently, the projected picture generating unit 107 maps the texture image to the polygon area (step S305). This process can be realized by a texture mapping function of a graphics processor.

Since a projected image as illustrated in FIG. 9 is generated in a frame memory of the graphics processor as a result, the projector 108 projects the projected image (step S306).

The description refers back to FIG. 11. Subsequently, the operation area recognizer 109 performs an operation area recognition process of recognizing an operation area from the image of the operation finger extracted by the extracting unit 102 (step S106).

Subsequently, the selection determining unit 110 performs a selection determination process of measuring the overlapping degree of the projection area recognized by the projection area recognizer 103 and the operation area recognized by the operation area recognizer 109, and determining whether or not the GUI projected on the projection area is selected (step S107).

Details of the selection determination process will be described here.

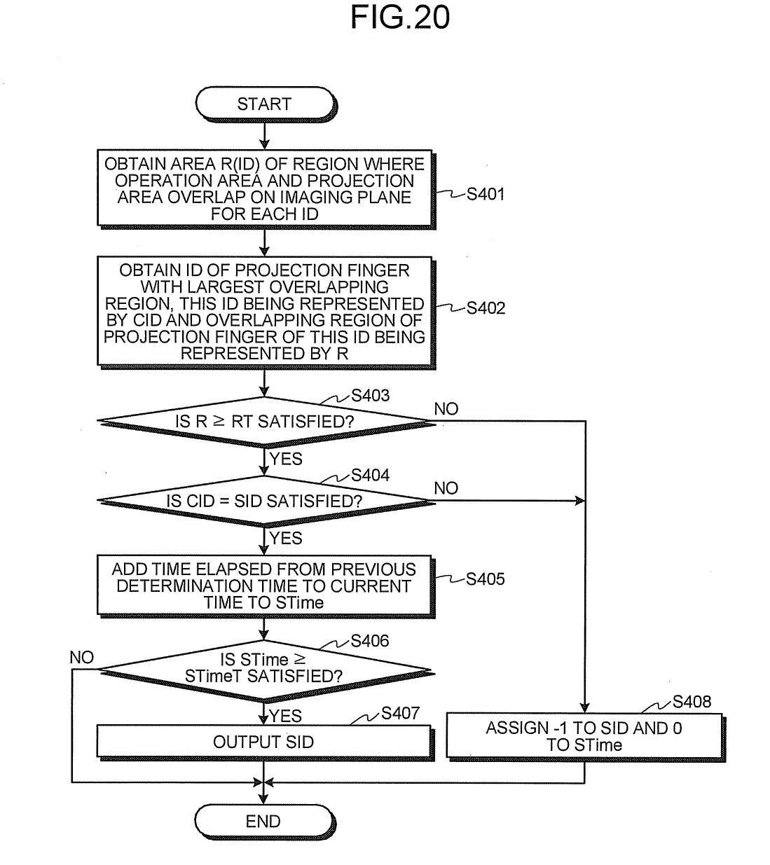

FIG. 20 is a flowchart illustrating an example of the selection determination process according to the first embodiment. In the example illustrated in FIG. 20, the selection determining unit 110 has internal variables, which are a variable SID for storing the ID of a projection finger overlapping with the operation finger and a variable STime for storing the time elapsed since the overlapping is started. SID can have a value in the range of 1 to 4 or a value “−1” of invalid indicating that the operation finger overlaps with none of the projection fingers. STime can be a real number in the range of 0 or greater. On start-up of the command issuing device 1, the selection determining unit 110 initializes SID to −1 and STime to 0.

First, the selection determining unit 110 obtains an area R (ID) of an overlapping region of the operation area of the operation finger and the projection area of the projection finger on the imaging plane for each ID of the projection fingers (step S401).

Subsequently, the selection determining unit 110 obtains the ID of a projection finger with the largest overlapping area, sets the value thereof to CID, and sets the overlapping area of the projection finger with this ID to R (step S402).

Subsequently, the selection determining unit 110 compares R with a threshold RT (step S403).

If R≧RT is satisfied (Yes in step S403), the selection determining unit 110 determines whether or not CID and SID are equal (step S404).

If CID=SID is satisfied (Yes in step S404), the selection determining unit 110 adds the time elapsed from the previous determination time to the current time to STime (step S405).

Subsequently, the selection determining unit 110 compares STime with a threshold STimeT of the selection time (step S406).

If STime≧StimeT is satisfied (Yes in step S406), the selection determining unit 110 determines that the operator 21 has chosen the GUI of SID, outputs SID to the issuing unit 105A (step S407), and terminates the process.

If R≧RT is not satisfied (No in step S403) or CID=SID is not satisfied (No in step S404), on the other hand, the selection determining unit 110 determines that the operator 21 has not selected the GUI, initializes SID to −1 and STime to 0 (step S408), and terminates the process. If STime≧STimeT is not satisfied (No in step S406), the selection determining unit 110 terminates the process.

As described above, according to the first embodiment, operation of an external device to be controlled can be completed by making one-hand operation of viewing a GUI picture projected onto a projection finger and touching the GUI by the operation finger. Moreover, since the state of an external device to be controlled can also be displayed as a GUI picture, it is possible to check the external device to be controlled in the picture projected onto a projection finger. Although a case where the operation finger and the projection fingers are all of one hand is described in the first embodiment, even in a case where both hands are used and a finger of a hand opposite to the hand with projection fingers is an operation finger, the position of the operation area can be detected by adding a color marker to the operation finger of the hand opposite to the hand with the projection fingers and this can be implemented by the above-described technique. Alternatively, an operation finger and projection fingers may be arranged on fingers of one hand and a further operation finger may be assigned to the opposite hand, further projection fingers may be assigned thereto, or both of the operation finger and the projection fingers can also be assigned thereto.

### Modified Example 1

While an example in which the operator 21 selects a GUI by laying the operation finger over the GUI picture on a projection finger is described in the first embodiment above, an example in which the operator 21 selects a GUI by bending a projection finger on which the GUI picture to be selected is projected instead of using an operation finger by the operator 21 will be described in the modified example 1. In the following, the difference from the first embodiment will be mainly described and components having similar functions as in the first embodiment will be designated by the same names and reference numerals as in the first embodiment, and the description thereof will not be repeated.

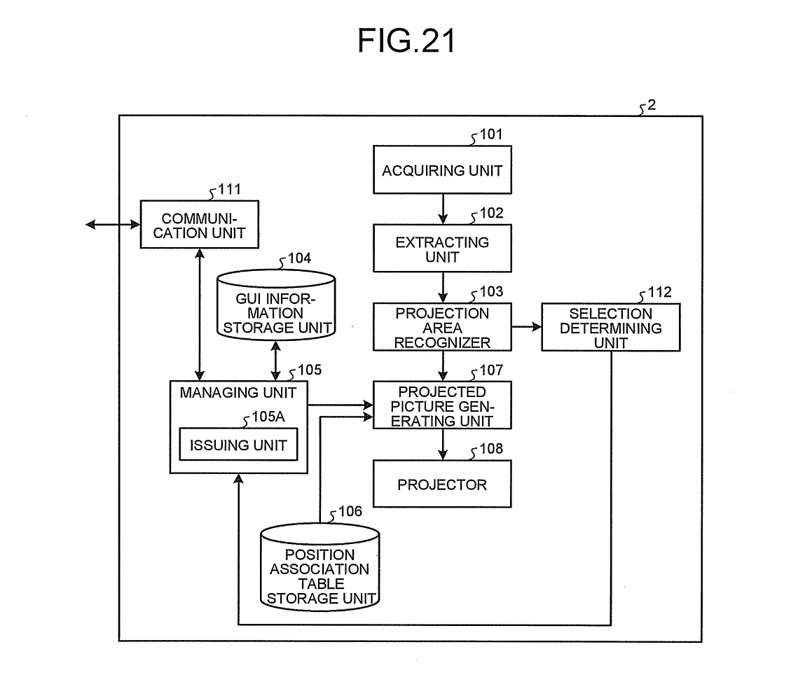

FIG. 21 is a configuration diagram illustrating an example of a command issuing device 2 according to the modified example 1. The modified example 1 differs from the first embodiment in the process performed by a selection determining unit 112.

The selection determining unit 112 measures the bending degree of a projection finger and determines whether or not the GUI is selected. Specifically, the selection determining unit 112 assigns a point with the largest x-coordinate out of the points of the rectangle Fn0Fn1Fn2Fn3 (projection area) to bn for each of the projection fingers. Here, n=1 to 4. Next, the selection determining unit 112 obtains an average value bAvg of bn and regards bn−bAvg as the bending amount. The selection determining unit 112 then compares the bending amount bn−bAvg with a predetermined threshold bT, and determines that a projection finger with an ID n is bent, that is, a GUI projected onto a projection area of a projection finger with an ID n is selected if bn−bAvg≦bT is satisfied, and outputs the determination result to the managing unit 105. If bn−bAvg>bT is satisfied for all the fingers, on the other hand, the selection determining unit 112 determines that none of the projection fingers is bent, that is, none of the GUIs is selected, and outputs the determination result to the managing unit 105.

Accordingly, the operator 21 can select a GUI by bending a projection finger onto which a picture of a GUI to be selected is projected.

The number of selectable GUIs may be more than one, and the selection determining unit 112 may prioritize the projection fingers in descending order of the bending amount, and selects GUIs projected onto projection areas of two or more projection fingers in descending order of the priority may be selected at the same time, for example.

Alternatively, the first embodiment and the modified example 1 may be combined such that selection of a GUI by laying the operation finger over a GUI picture on a projection finger and selection of a GUI by bending by the operator 21 a projection finger onto which a picture of the GUI to be selected is projected are combined.

### Modified Example 2

While an example in which one GUI is projected onto one projection finger is described in the first embodiment, an example in which a plurality of GUIs are projected onto one projection finger will be described in the modified example 2. In the following, the difference from the first embodiment will be mainly described and components having similar functions as in the first embodiment will be designated by the same names and reference numerals as in the first embodiment, and the description thereof will not be repeated.

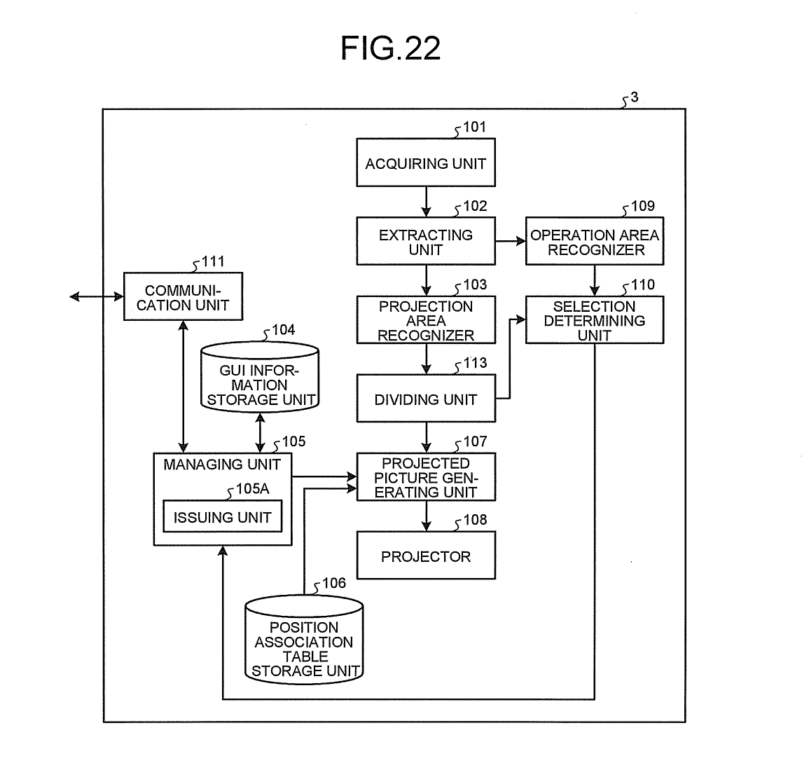

FIG. 22 is a configuration diagram illustrating an example of a command issuing device 3 according to the modified example 2. The modified example 2 differs from the first embodiment in that the command issuing device 3 further includes a dividing unit 113.

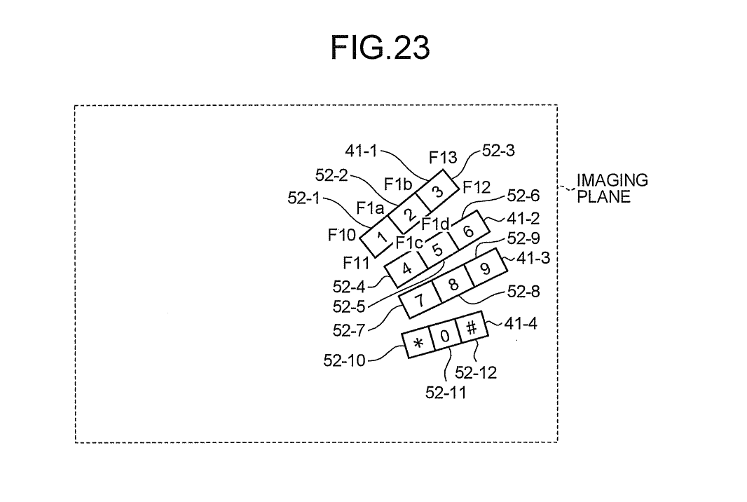

The dividing unit 113 divides a projection area recognized by the projection area recognizer 103 into a plurality of divided projection areas. FIG. 23 is an explanatory diagram illustrating an example of a dividing technique for the dividing unit 113 according to the modified example 2. In the example illustrated in FIG. 23, the dividing unit 113 divides a rectangle F10F11F12F13 that is the projection area 41-1 recognized by the projection area recognizer 103 into three rectangles: a rectangle F10F11F1cF1a that is a first divided projection area, a rectangle F1aF1cF1dF1b that is a second divided projection area, and a rectangle F1bFdF12F13 that is a third divided projection area. Note that the dividing unit 113 may divide the projection area on the basis of the positions of the joints of the projection finger, or may simply divide the projection area evenly.

In the example illustrated in FIG. 23, information of numerical keys is stored as the GUI information in the GUI information storage unit 104, and a button 1 is assigned to the rectangle F10F11F1cF1a that is the first divided projection area, a button 2 is assigned to the rectangle F1aF1cF1dF1b that is the second divided projection area, and a button 3 is assigned to the rectangle F1bF1dF12F13 that is the third divided projection area. The projecting unit 108 thus projects a GUI picture 52-1 of the button 1 onto the rectangle F10F11F1cF1a that is the first divided projection area, a GUI picture 52-2 of the button 2 onto the rectangle F1aF1cF1dF1b that is the second divided projection area, and a GUI picture 52-3 of the button 3 onto the rectangle F1bF1dF12F13 that is the third divided projection area.

The selection determining unit 110 determines whether or not a GUI is selected by measuring the overlapping degree of the operation area and a divided projection area.

As a result, it is possible to project numerical keys or the like onto the projection fingers and to project more various menus.

### Modified Example 3

In a case where the operator 21 selects a GUI by bending a projection finger onto which a picture of the GUI to be selected is projected as in the modified example 1, a silhouette image acquired by an infrared sensor may be used as a feature value.

In this case, the acquiring unit 101 irradiates the hand 22 with infrared light from an infrared light source and captures the infrared light diffusely reflected by the surface of the hand 22 with an infrared camera with a filter that only transmits infrared rays instead of using a visible light camera.

In addition, since the reflected infrared light is attenuated in the background area other than the hand 22, the extracting unit 102 can separate the area of the hand 22 from the background area other than the hand 22 by extracting only an area where the infrared rays are reflected at an intensity equal to or higher than a certain threshold. In this manner, the extracting unit 102 extracts a silhouette image of the hand 22.

In addition, the projection area recognizer 103 can recognize a projection area of a projection finger from the silhouette image of the hand 22 by tracing the outline of the silhouette of the hand 22 and extracting an inflection point of the outline.

Accordingly, the operator 21 can select a GUI by bending a projection finger without attaching a color marker to the projection finger.

### Modified Example 4

While the operator 21 recognizes the positions of the operation finger and the projection fingers on the imaging plane by recognizing the colors of the color markers attached to the fingers using a visible light camera in the first embodiment, an example in which the positions of the operation finger and the projection fingers on the imaging plane are recognized by using a distance sensor instead of the visible light camera will be described in the modified example 4.

A distance sensor is a sensor that obtains a distance from a camera to an object as an image. For example, there is a method of irradiating the hand 22 by using an infrared light source installed near an infrared camera and obtaining the intensity of the reflected light as a distance by utilizing the property that reflected light is attenuated as the distance is longer. There is also a method of projecting a specific pattern by using a laser light source or the like and obtaining a distance by utilizing the property that the reflection pattern on an object surface changes depending on the distance. In addition, there is also a method of obtaining a distance by image processing utilizing the property that the parallax between images captured by two visible light cameras installed with a distance therebetween is larger as the distance to the object is shorter. The acquiring unit 101 may obtain the distance by any method in the modified example 4.

As described above, the acquiring unit 101 acquires an image (hereinafter referred to as a distance image) expressing the distance from the command issuing device 1 to the hand 22 or the background as a luminance in the modified example 4.

Note that the distance d from the command issuing device 1 to the hand 22 or the background is stored as a numerical value in the pixels of the distance image. The value of d is smaller as the distance is shorter and larger as the distance is longer.

The extracting unit 102 divides the distance image into an area of the bent operation finger, an area of the projection fingers and the palm, and a background area on the basis of the distribution of the distance d by using thresholds dTs and dTp. The extracting unit 102 then extracts an area where d<dTs is satisfied as the area of the bent operation finger, determines an inflection point of the outline of the silhouette of this area, and outputs a tip area of the operation finger to the operation area recognizer 109. The extracting unit 102 also extracts an area where dTs≦d<dTp is satisfied as the area of the projection fingers and the palm, determines an inflection point of the outline of the silhouette of this area, and outputs an area from the bases to the tips of the projection fingers to the projection area recognizer 103.

In this manner, it is possible to recognize the positions of the operation finger and the projection fingers on the imaging plane without using color markers.

### Second Embodiment

In the second embodiment, an example in which pictures of GUIs projected onto projecting fingers are switched according to the posture of a hand will be described. In the following, the difference from the first embodiment will be mainly described and components having similar functions as in the first embodiment will be designated by the same names and reference numerals as in the first embodiment, and the description thereof will not be repeated.

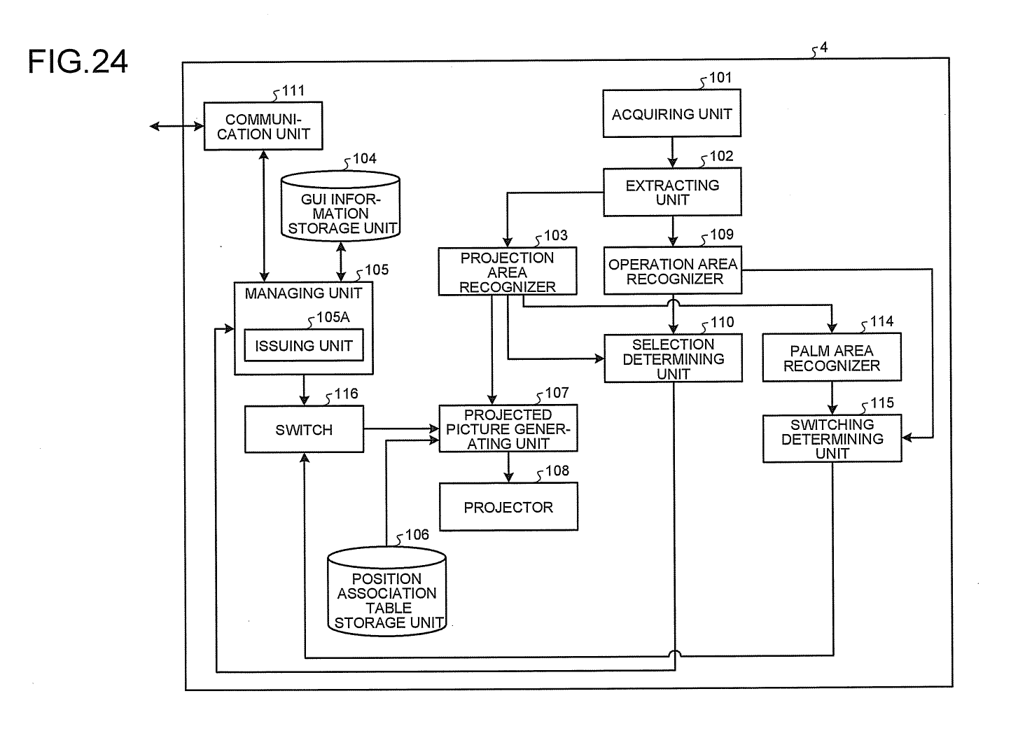

FIG. 24 is a configuration diagram illustrating an example of a command issuing device 4 according to the second embodiment. The second embodiment differs from the first embodiment in that the command issuing device 4 further includes a palm area recognizer 114, a switching determining unit 115, and a switch 116.

The palm area recognizer 114 recognizes a palm area by using a projection area recognized by the projection area recognizer 103. Specifically, the palm area recognizer 114 extracts a shape feature value of the palm by using the projection area recognized by the projection area recognizer 103 and recognizes the area represented by the extracted feature value as the palm area.

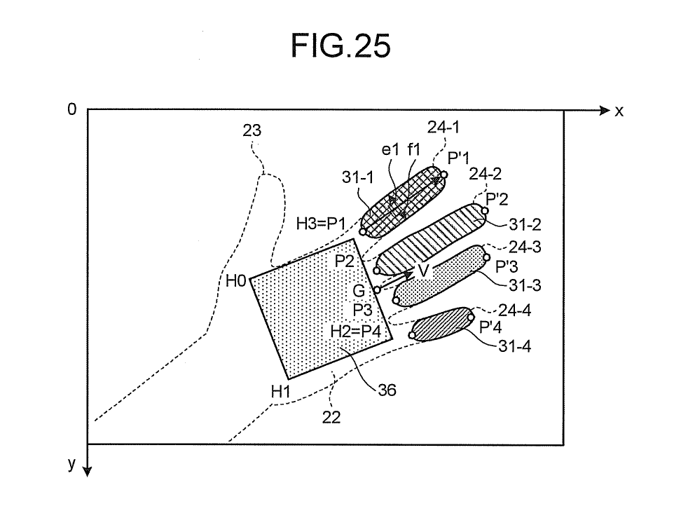

FIG. 25 is an explanatory diagram illustrating an example of a technique for recognizing the palm area for the palm area recognizer 114 according to the second embodiment. In the example illustrated in FIG. 25, the palm area recognizer 114 recognizes a palm area 36 representing the palm as a square H0H1H2H3. H3 corresponds to P1 (the base of the index finger 24-1) set by the projection area recognizer 103 and H2 corresponds to P4 (the base of the little finger 24-4) set by the projection area recognizer 103. In other words, the palm area recognizer 114 obtains a line H2H3 and recognizes a square H0H1H2H3 with the line H2H3 as a side thereof. The line H0H1 is a line having the same length as the line H2H3 and perpendicular thereto. The technique for recognizing the palm area 36 is not limited to the above but the palm area 36 may alternatively be recognized by using information such as color information of the palm surface.

The switching determining unit 115 measures the overlapping degree of the palm area recognized by the palm area recognizer 114 and the operation area recognized by the operation area recognizer 109, and determines whether to switch the GUIs to be projected onto the projection areas. The switching determining unit 115 makes determination by a technique similar to that for the selection determining unit 110. If the overlapping area of the palm area and the operation area is equal to or larger than HT for a predetermined time HTimeT or longer, the switching determining unit 115 determines that the GUIs to be projected onto the projection areas are to be switched to GUIs of a first state. On the other hand, if the overlapping area of the palm area and the operation area is not equal to or larger than HT for the predetermined time HTimeT or longer, the switching determining unit 115 determines that the GUIs to be projected onto the projection areas are to be switched to GUIs of a second state.

If the switching determining unit 115 determines that the GUI pictures are to be switched to the GUIs of the first state, the switch 116 switches the GUIs to be projected onto the projection areas to the GUIs of the first state, and if the switching determining unit 115 determines that the GUI pictures are to be switched to the GUIs of the second state, the switch 116 switches the GUIs to be projected onto the projection areas to the GUIs of the second state.

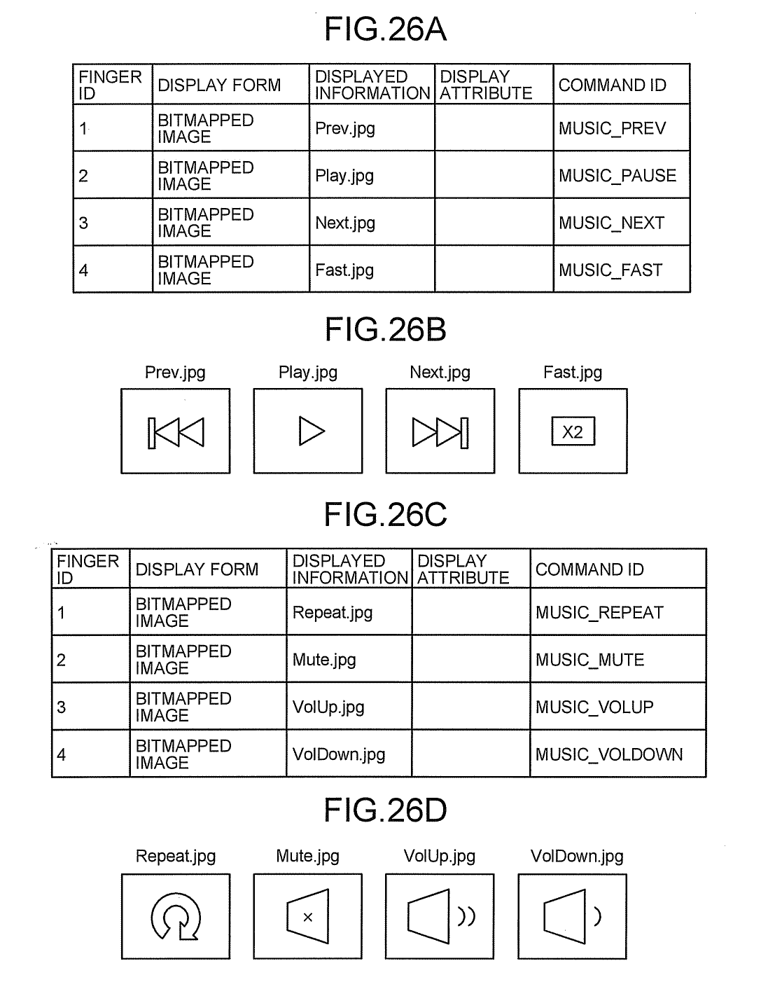

For example, the GUI information storage unit 104 stores therein GUI information illustrated in FIGS. 26A to 26D, in which the GUI information illustrated in FIGS. 26A and 26B represents the GUIs of the first state and the GUI information illustrated in FIGS. 26C and 26D represents the GUIs of the second state.

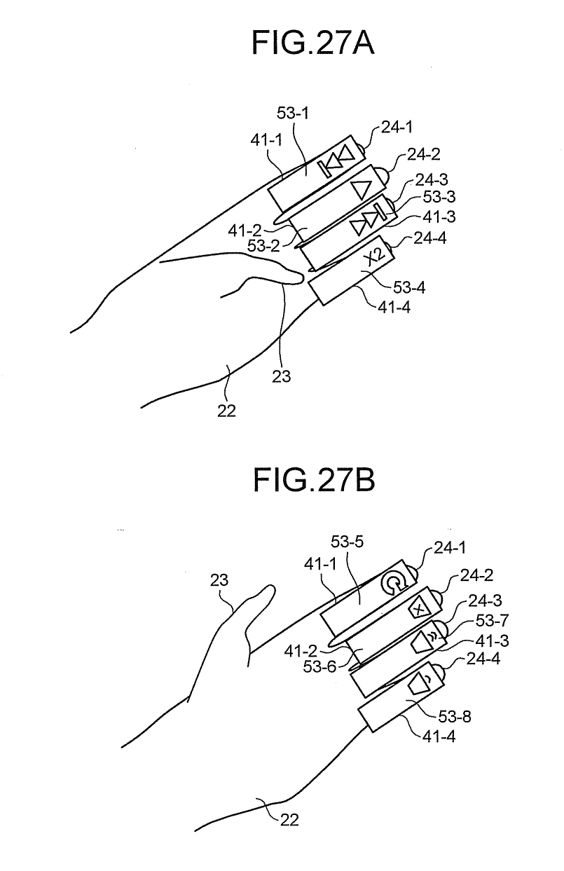

In this case, if the operator 21 lays the thumb 23 over the palm area 36 and the switching determining unit 115 determines to switch to the GUIs of the first state, the switch 116 sets the GUI information illustrated in FIGS. 26A and 26B and GUIs 53-1 to 53-4 are projected onto the projection areas 41-1 to 41-4, respectively, as illustrated in FIG. 27A.

On the other hand, if the operator 21 does not lay the thumb 23 over the palm area 36 and the switching determining unit 115 determines to switch to the GUIs of the second state, the switch 116 sets the GUI information illustrated in FIGS. 26C and 26D and GUIs 53-5 to 53-8 are projected onto the projection areas 41-1 to 41-4, respectively, as illustrated in FIG. 27B.

If the operator 21 lays the operation finger over the palm and then moves the operation finger over a projection finger, the switching determining unit 115 may make switching determination that the previous state of laying the operation finger over the palm is held even if the operation finger is not over the palm any longer.

As a result, it is possible to switch the display of the GUIs according to whether or not the operator 21 takes the posture of laying the operation finger over the palm. Alternatively, the projection may be performed such that the GUIs are not projected onto the projection fingers when the operator 21 does not lay the operation finger over the palm and GUIs are projected onto the projection fingers when the operator 21 lays the operation finger over the palm.

According to the second embodiment, even when there are a number of GUI elements to be projected and the number of GUI elements is not fixed, it is possible to display a plurality of GUI elements by switching the displayed information.

### Modified Example 5

While an example in which the operator 21 switches the GUIs by laying the operation finger over the palm is described in the second embodiment above, an example in which the operator 21 switches the GUIs by opening and closing the projection fingers will be described in the modified example 5. In the following, the difference from the second embodiment will be mainly described and components having similar functions as in the second embodiment will be designated by the same names and reference numerals as in the second embodiment, and the description thereof will not be repeated.

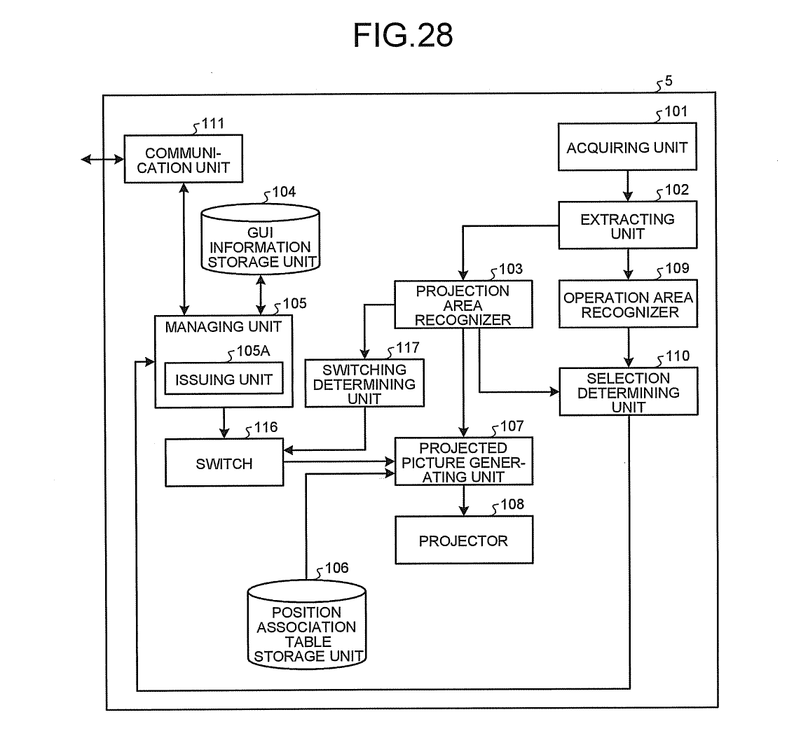

FIG. 28 is a configuration diagram illustrating an example of a command issuing device 5 according to the modified example 5. The modified example 5 differs from the second embodiment in the process performed by a switching determining unit 117.

The switching determining unit 117 measures the opening degrees of the projection fingers to determine whether or not to switch the GUIs to be projected onto the projection areas. If the projection fingers are open, the switching determining unit 117 determines to switch the GUIs to be projected onto the projection areas to the GUIs of the first state. If the projection fingers are not open, on the other hand, the switching determining unit 117 determines to switch the GUIs to be projected onto the projection areas to the GUIs of the second state.

Specifically, the switching determining unit 117 compares a sum dSum of absolute values of scalar products dn of a directional vector Vs that is a sum of directional vectors SnR′n of the base positions Sn of estimated projection fingers and the directional vectors SnR′n of the respective projection fingers with a threshold dT. If dSum≦dT is satisfied, the switching determining unit 117 determines that the fingers are open and to switch the GUIs to be projected onto the projection areas to the GUIs of the first state. If dSum>dT is satisfied, on the other hand, the switching determining unit 117 determines that the fingers are closed and to switch the GUIs to be projected onto the projection areas to the GUIs of the second state.

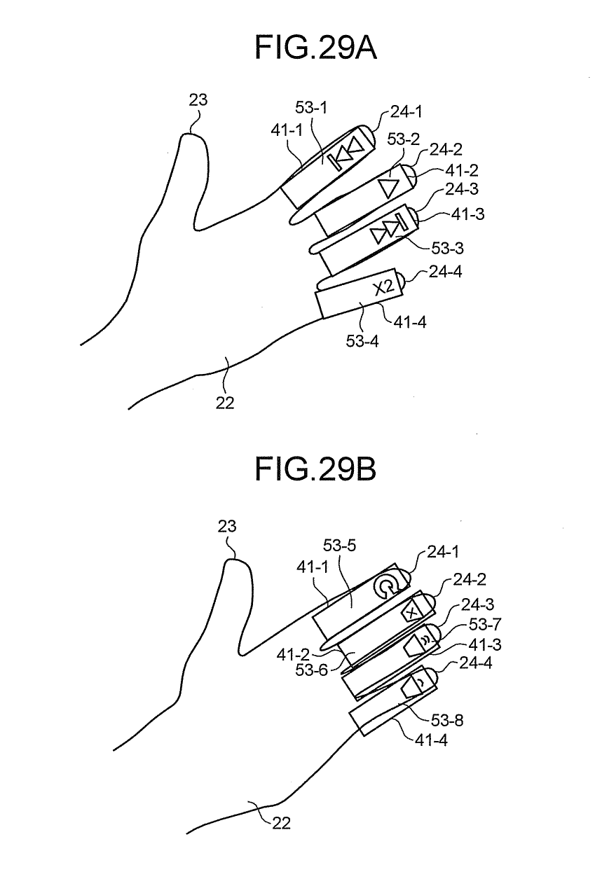

For example, if the operator 21 opens the fingers and the switching determining unit 117 determines to switch to the GUIs of the first state, the switch 116 sets the GUI information illustrated in FIGS. 26A and 26B, and the GUIs 53-1 to 53-4 are projected onto the projection areas 41-1 to 41-4, respectively, as illustrated in FIG. 29A.

On the other hand, if the operator 21 closes the fingers and the switching determining unit 117 determines to switch to the GUIs of the second state, the switch 116 sets the GUI information illustrated in FIGS. 26C and 26D, and the GUIs 53-5 to 53-8 are projected onto the projection areas 41-1 to 41-4, respectively, as illustrated in FIG. 29B.

As a result, it is possible to switch the display of the GUIs according to whether or not the operator 21 takes the hand posture of opening the projection fingers. Alternatively, the projection may be performed such that the GUIs are not projected onto the projection fingers when the operator 21 closes the projection fingers and the GUIs are projected onto the projection fingers when the operator 21 opens the projection fingers.

### Modified Example 6

While an example in which the operator 21 switches the GUIs by laying the operation finger over the palm is described in the second embodiment above, an example in which the operator 21 switches the GUIs by changing the direction of the projection fingers will be described in the modified example 6. In the following, the difference from the second embodiment will be mainly described and components having similar functions as in the second embodiment will be designated by the same names and reference numerals as in the second embodiment, and the description thereof will not be repeated.

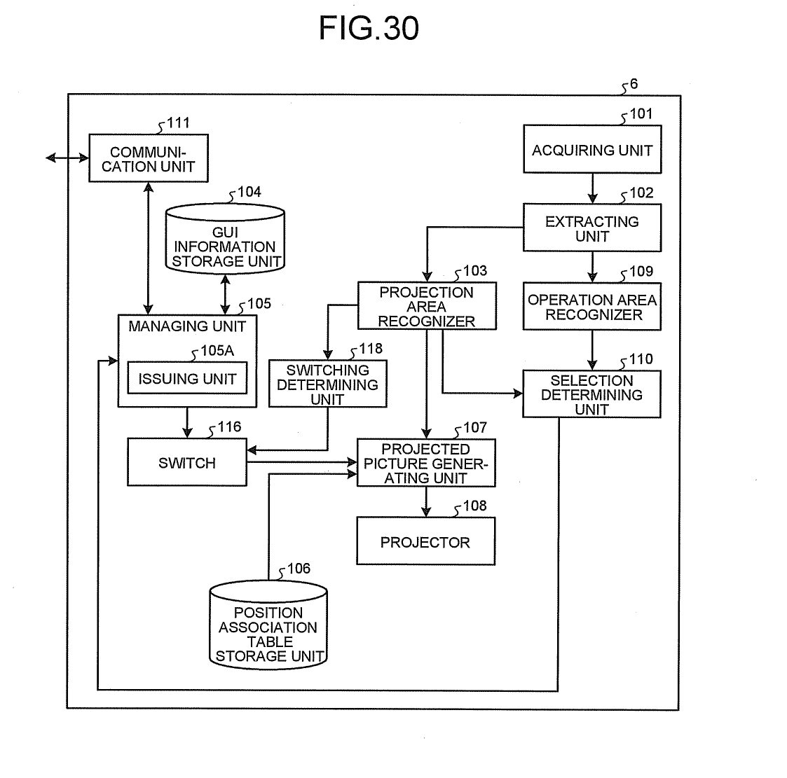

FIG. 30 is a configuration diagram illustrating an example of a command issuing device 6 according to the modified example 6. The modified example 6 differs from the second embodiment in the process performed by a switching determining unit 118.

The switching determining unit 118 measures the direction of the projection fingers to determine whether or not to switch the GUIs to be projected onto the projection areas. If the projection fingers are oriented in the vertical direction, the switching determining unit 118 determines to switch the GUIs to be projected onto the projection areas to the GUIs of the first state. If the projection fingers are oriented in the horizontal direction, on the other hand, the switching determining unit 118 determines to switch the GUIs to be projected onto the projection areas to the GUIs of the second state.

Specifically, the switching determining unit 118 obtains an angle aS of the directional vector Vs that is a sum of directional vectors SnR′n of the base positions Sn of estimated projection fingers with respect to the horizontal direction of the imaging plane, and compares aS with a threshold aST. If aS≧aST is satisfied, the switching determining unit 118 determines that the projection fingers are oriented in the vertical direction and to switch the GUIs to be projected onto the projection areas to the GUIs of the first state. If aS<aST is satisfied, on the other hand, the switching determining unit 118 determines that the hand is oriented in the horizontal direction and to switch the GUIs to be projected onto the projection areas to the GUIs of the second state.

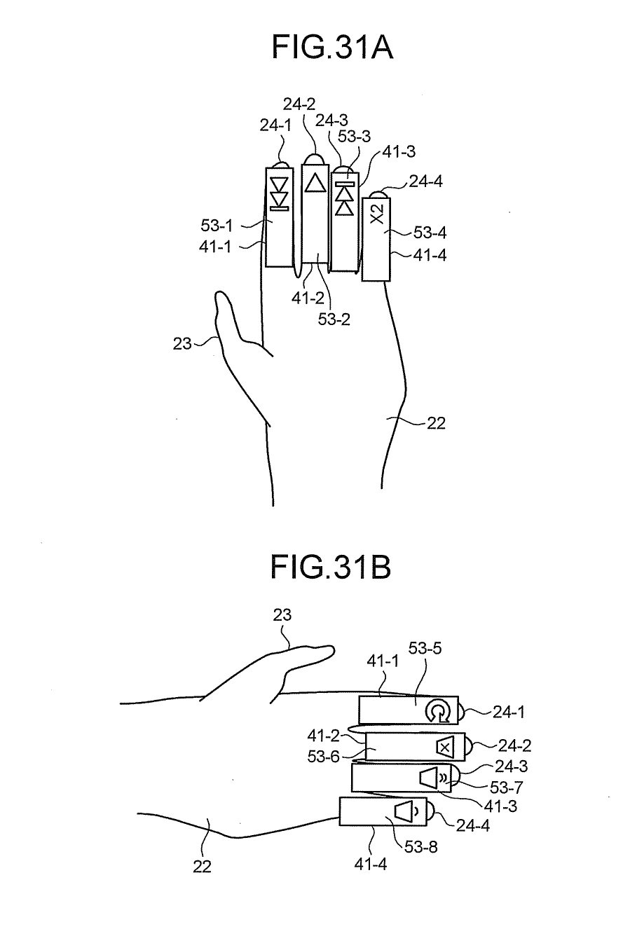

For example, if the operator 21 orients the projection fingers in the vertical direction and the switching determining unit 118 determines to switch to the GUIs of the first state, the switch 116 sets the GUI information illustrated in FIGS. 26A and 26B, and the GUIs 53-1 to 53-4 are projected onto the projection areas 41-1 to 41-4, respectively, as illustrated in FIG. 31A.

On the other hand, if the operator 21 orients the projection fingers in the horizontal direction and the switching determining unit 118 determines to switch to the GUIs of the second state, the switch 116 sets the GUI information illustrated in FIGS. 26C and 26D, and the GUIs 53-5 to 53-8 are projected onto the projection areas 41-1 to 41-4, respectively, as illustrated in FIG. 31B.

As a result, it is possible to switch the display of the GUIs according to the direction in which the operator 21 orients the projection fingers (the posture of the hand). Alternatively, the projection may be performed such that the GUIs are not projected onto the projection fingers when the operator 21 orients the projection fingers in the horizontal direction and the GUIs are projected onto the projection fingers when the operator 21 orients the projection fingers in the vertical direction.

### Modified Example 7

While an example in which the operator 21 switches the GUIs by laying the operation finger over the palm is described in the second embodiment above, an example in which the operator 21 switches the GUIs by changing the position of the operation finger relative to the projection fingers will be described in the modified example 7. In the following, the difference from the second embodiment will be mainly described and components having similar functions as in the second embodiment will be designated by the same names and reference numerals as in the second embodiment, and the description thereof will not be repeated.

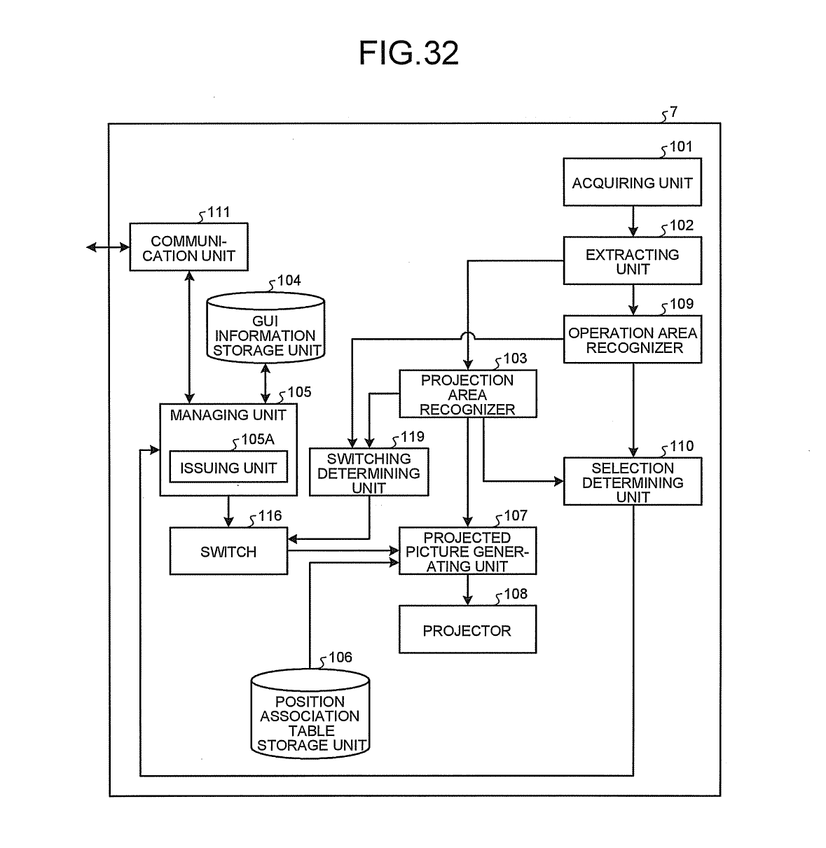

FIG. 32 is a configuration diagram illustrating an example of a command issuing device 7 according to the modified example 7. The modified example 7 differs from the second embodiment in the process performed by a switching determining unit 119.

The switching determining unit 119 measures the relative positions of the operation area and the projection areas to determine whether or not to switch the GUIs to be projected onto the projection areas. If the distance between the operation area and the projection areas is equal to or longer than a threshold, the switching determining unit 119 determines that the operation finger and the projection fingers are apart from each other and to switch the GUIs to be projected onto the projection areas to the GUIs of the first state. If the distance between the operation area and the projection areas is not equal to or longer than the threshold, on the other hand, the switching determining unit 119 determines that the operation finger and the projection fingers are not apart from each other and to switch the GUIs to be projected onto the projection areas to the GUIs of the second state.

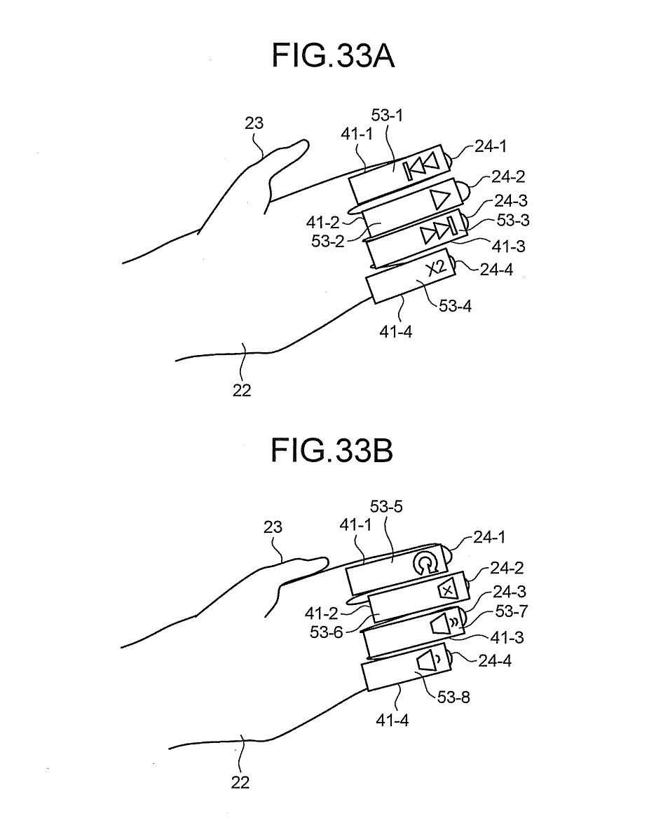

For example, if the operator 21 separates the operation finger and the projection fingers and the switching determining unit 119 determines to switch to the GUIs of the first state, the switch 116 sets the GUI information illustrated in FIGS. 26A and 26B, and the GUIs 53-1 to 53-4 are projected onto the projection areas 41-1 to 41-4, respectively, as illustrated in FIG. 33A.

On the other hand, if the operator 21 brings the operation finger and the projection fingers together and the switching determining unit 119 determines to switch to the GUIs of the second state, the switch 116 sets the GUI information illustrated in FIGS. 26C and 26D, and the GUIs 53-5 to 53-8 are projected onto the projection areas 41-1 to 41-4, respectively, as illustrated in FIG. 33B.

As a result, it is possible to switch the display of the GUIs according to the relative positions of the operation finger and the projection fingers (the posture of the hand). Alternatively, the projection may be performed such that the GUIs are not projected onto the projection fingers when the operator 21 brings the operation finger and the projection fingers together and the GUIs are projected onto the projection fingers when the operator 21 separates the operation finger and the projection fingers.

Alternatively, the moving direction of the operation finger may be detected when the operator 21 makes an operation of tracing the projection fingers with the operation finger, and the GUIs may be switched depending on whether the operation finger has traced the projecting fingers from the bases to the tips or from the tips to the bases.

### Third Embodiment

In the third embodiment, an example in which a feedback picture allowing the operator to view a current operation is projected will be described. In the following, the difference from the first embodiment will be mainly described and components having similar functions as in the first embodiment will be designated by the same names and reference numerals as in the first embodiment, and the description thereof will not be repeated.

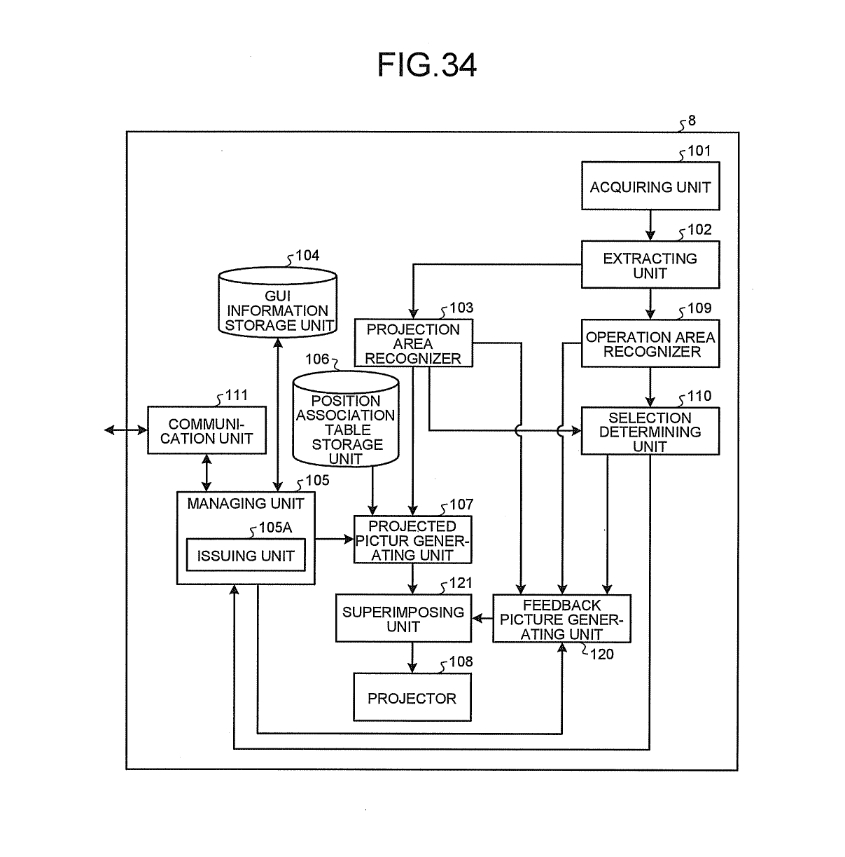

FIG. 34 is a configuration diagram illustrating an example of a command issuing device 8 according to the third embodiment. The third embodiment differs from the first embodiment in that the command issuing device 8 further includes a feedback picture generating unit 120 and a superimposing unit 121.

The feedback picture generating unit 120 generates a feedback picture for a GUI picture that is projected onto a projection area with which the operation area is determined to overlap by the selection determining unit 110. Herein, a feedback picture is a projected picture allowing the operator 21 to view the current operation.

When the operator 21 lays the operation finger over a GUI picture on a projection finger, the projected picture is projected across the operation finger and the projection finger, and the visibility of the GUI picture on the projection finger is lowered. The feedback picture generating unit 120 thus projects the GUI picture on the projection finger that the operator 21 is about to select onto an area other than the projection finger or shortens the GUI picture and projects the shortened picture on a region of the projection area of the projection finger where the operation finger does not overlap.

While the selection determining unit 110 determines that the GUI is selected when the operation area and the projection area overlap with each other for a predetermined time or longer, the feedback picture generating unit 120 generates a feedback picture as long as the operation area and the projection area overlap with each other.

In other words, the feedback picture generating unit 120 only makes determination on the conditions of steps S403 and S404 in the flowchart illustrated in FIG. 20 but does not make determination on the elapsed time. The feedback picture generating unit 120 then generates a feedback picture for the GUI picture projected on the projection finger with an ID exceeding a threshold.

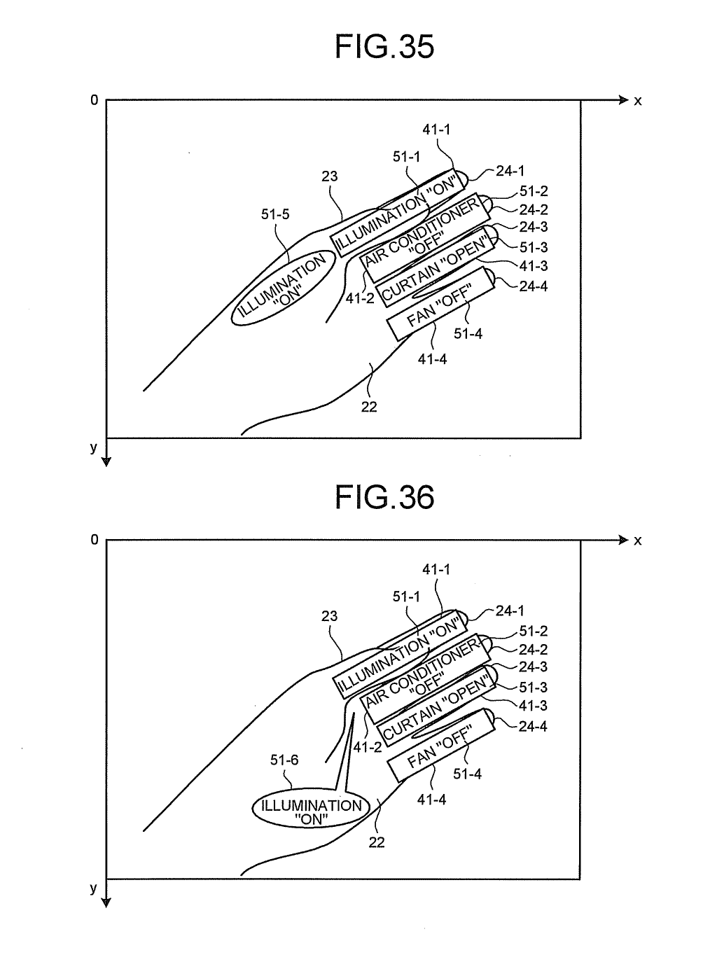

For example, the projector 108 projects a feedback picture 51-5 for the GUI 51-1 that the operator 21 is about to select onto the base of the operation finger as illustrated in FIG. 35. The feedback picture generating unit 120 determines the projected position of the feedback picture 51-5 by classifying into a case where the base of the projection finger is selected and a case where the tip of the projection finger is selected by the operation finger. This classification may be made by dividing the projection area into two regions, which are a tip side region and a base side region, and determining which of the regions the center position of the operation finger overlaps with. If the operator 21 has selected the base of the projection finger, the projected position is a point away from the base position of the index finger 24-1 by the length of the index finger 24-1 in the direction toward the palm (a point obtained by extending the line R′1S1 by the length of the line R′1S1 from S1 in the direction of the directional vector R′1S1 in FIG. 18). If the operator 21 has selected the tip of the projection finger, on the other hand, the projected position is a point away from the middle point of the point at the base position of the projection finger selected by the operation finger and the point at the base position of the index finger 24-1 by the length of the index finger 24-1 in the direction toward the palm (a point obtained by extending the line R′1S1 by the length of the line R′1S1 illustrated in FIG. 18 from the middle point of the point at the base position of the projection finger selected by the operation finger and the point at the base position of the index finger 24-1 in the direction of the directional vector line R′1S1).

Alternatively, for example, the projector 108 may project a feedback picture 51-6 for the GUI 51-1 that the operator 21 is about to select onto the palm as illustrated in FIG. 36.

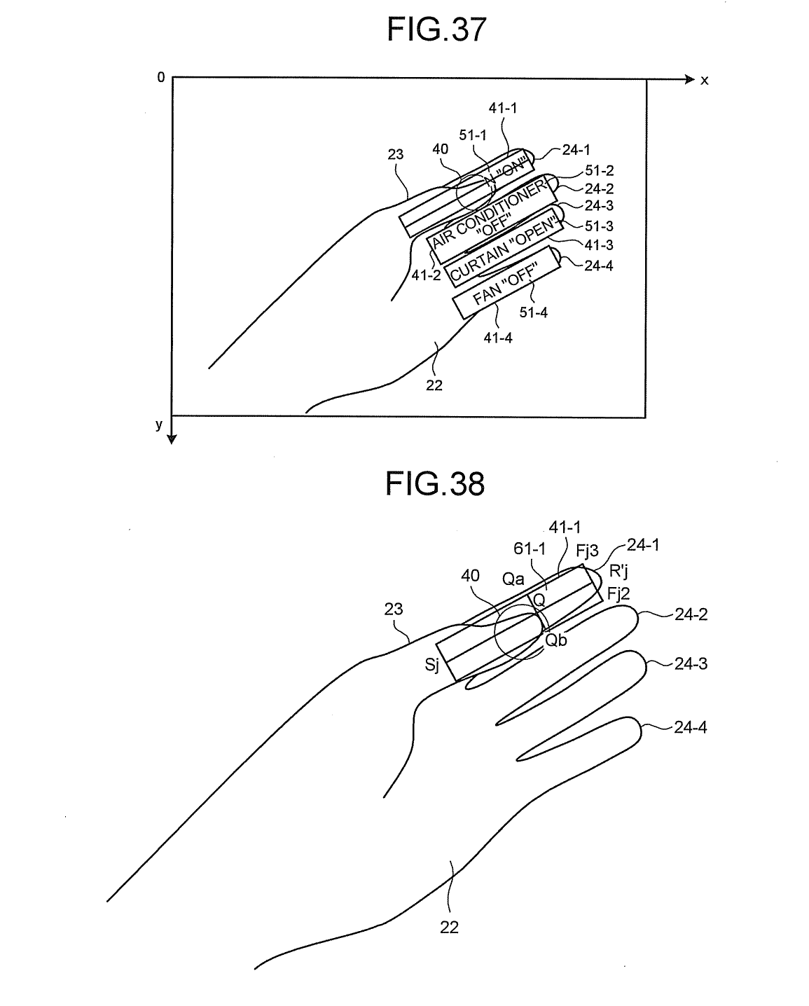

Still alternatively, for example, the projector 108 may project a shortened or zoomed out version of the GUI 51-1 that the operator 21 is about to select as illustrated in FIG. 37.

In this case, shortened texts or zoomed out pictures corresponding to the respective pieces of the GUI information are stored in the GUI information storage unit 104. For example, when the GUI information storage unit 104 stores therein a shortened text “N ON” for “ILLUMINATION ON” and the operator 21 is about to select the GUI 51-1, the projector 108 projects the shortened text “N ON” for “ILLUMINATION ON”. A region 61-1 of the projection finger without the operation finger laying thereover can be obtained as a rectangle QaQbFj2Fj3 by obtaining an intersection Q of a directional vector R′jSj for a projection finger with an ID=j (j=1 to 4) that is being selected and a circle resulting from approximating the operation finger, and obtaining points Qa, Qb away from the endpoint Q of the line R′jQ by the feature values ej, fj representing the thickness of the fingers calculated in advance in the direction perpendicular to R′jQ as illustrated in FIG. 38. The number of characters of the text to be projected onto the region 61-1 of the projection finger without the operation finger laying thereover is dynamically changed depending on the length of the line QR′j defining the projection area. For example, thresholds La, Lb (|P1P′1|>La>Lb>0) are determined in advance, and the projector 108 projects “ILLUMINATION “ON”” when |QR′j|≧La is satisfied or “ILLU ON” when La>|QR′j|≧Lb is satisfied. When Lb>|QR′j| is satisfied, an icon image having a size small enough to be within the projection area may be displayed instead of a character string since the projection area is too small.

The superimposing unit 121 superimposes the projected picture generated by the projected picture generating unit 107 and the feedback picture generated by the feedback picture generating unit 120 to generate a composite picture.

According to the third embodiment, the operator 21 can more easily view the content of the GUI element that the operator 21 has selected and it is possible to reduce the possibility of performing erroneous operation by implementing this example.

### Fourth Embodiment

In the fourth embodiment, an example in which GUI information associated with the projection fingers is assigned will be described. In the following, the difference from the first embodiment will be mainly described and components having similar functions as in the first embodiment will be designated by the same names and reference numerals as in the first embodiment, and the description thereof will not be repeated.

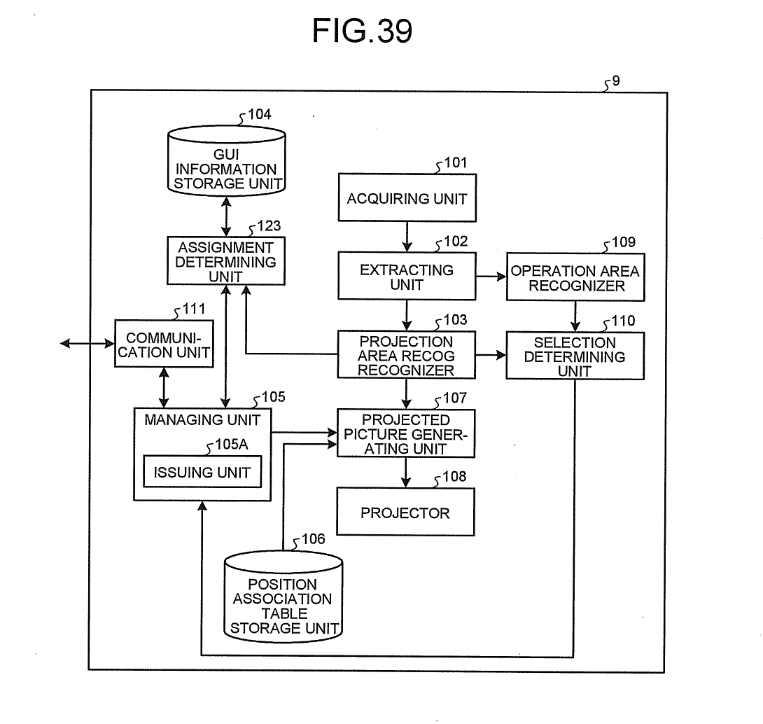

FIG. 39 is a configuration diagram illustrating an example of a command issuing device 9 according to the fourth embodiment. The fourth embodiment differs from the first embodiment in that the command issuing device 9 further includes an assignment determining unit 123.

The assignment determining unit 123 determines assignment of GUIs to respective projection areas of the projection fingers on the basis of the GUI information stored in the GUI information storage unit 104. As a result, it is possible to change the GUI information to be assigned to the projection fingers on the basis of the difference in displayable area based on the difference in the size of the projection fingers and the difference in easiness of selecting operation depending on the relative positions of the projection fingers.

For example, in the case where the thumb 23 is the operation finger and the fingers 24 other than the thumb are the projection fingers, a value representing the easiness of selecting operation for each finger is held in advance in the assignment determining unit 123 for each projection finger of GUI pictures, and the operation frequency for each GUI is obtained from information recording the operation history for each GUI and also held in advance in the assignment determining unit 123. As a result, the assignment determining unit 123 assigns the GUIs in descending order of the operation frequency to the projection fingers in descending order of the easiness of the selecting operation, and it is thus possible to more easily operate the GUI that is more frequently subjected to selecting operation and reduce the operation errors.

In addition, for example, when text character strings are to be displayed as GUI pictures, the number of characters of the text character string for each GUI is counted in advance in the assignment determining unit 123. The assignment determining unit 123 then assigns the GUIs in descending order of the number of characters in the text character strings to the projection fingers obtained from the projection area recognizer 103 in descending order of the number of pixels in the horizontal direction of the projection areas of the projection fingers. In other words, the assignment determining unit 123 assigns GUI elements with larger numbers of characters to longer fingers such as the index finger 24-1 and the middle finger 24-2 and GUI elements with small numbers of characters to shorter fingers such as the little finger 24-4, and it is thus possible to improve the visibility of the GUI characters strings and reduce the operation errors.

In addition, for example, for projecting a document including a plurality of lines of text or the like onto the projection fingers, the assignment determining unit 123 assigns the document so that one line of the text is projected onto one finger. In this case, the assignment determining unit 123 inserts line breaks in the middle of the text depending on the length of the projection fingers by using the projection areas of the projection fingers obtained from the projection area recognizer 103 to divide the text into a plurality of lines, and then assigns each line to each projection finger. As a result, it is possible to project and view a long sentence or the like on the projection fingers.

In this manner, it is possible to assign various GUIs that are not limited to the number of projection fingers onto the fingers according to the fourth embodiment.

### Fifth Embodiment

In the fifth embodiment, an example in which a head-mounted display (HMD) is used will be described. In the following, the difference from the first embodiment will be mainly described and components having similar functions as in the first embodiment will be designated by the same names and reference numerals as in the first embodiment, and the description thereof will not be repeated.

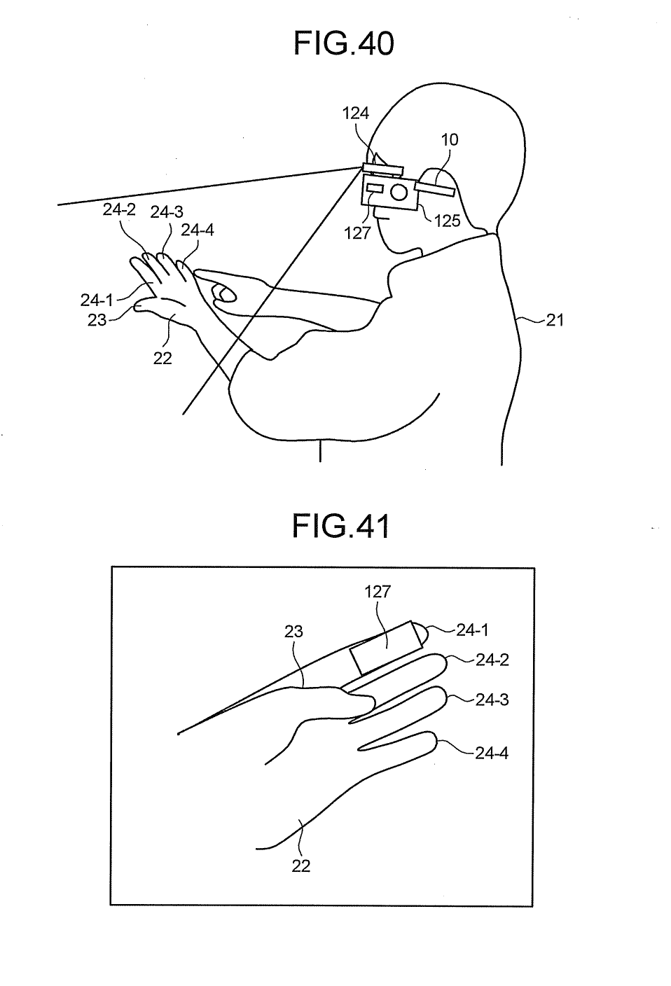

FIG. 40 is an outline view illustrating an example of use of a command issuing device 10 according to the fifth embodiment. In this embodiment, the command issuing device 10 is in a form of eyewear that can be worn on the head of the operator 21 as illustrated in FIG. 40. An acquiring unit 124 is oriented in the direction toward the hand 22 when the operator 21 turns his/her head toward the hand 22, and captures a moving image of the hand 22. A presenting unit 125 is an eyewear type display that the operator 21 can wear on his/her head, and presents a picture by superimposing the picture on a scenery the operator 21 is looking at. In the fifth embodiment, therefore, the presenting unit 125 presents a picture 127 at the position of the hand 22 in a state where the operator 21 is looking at the hand 22 so that it appears to the operator 21 as if the picture 127 is superimposed on the hand 22 as illustrated in FIG. 41.

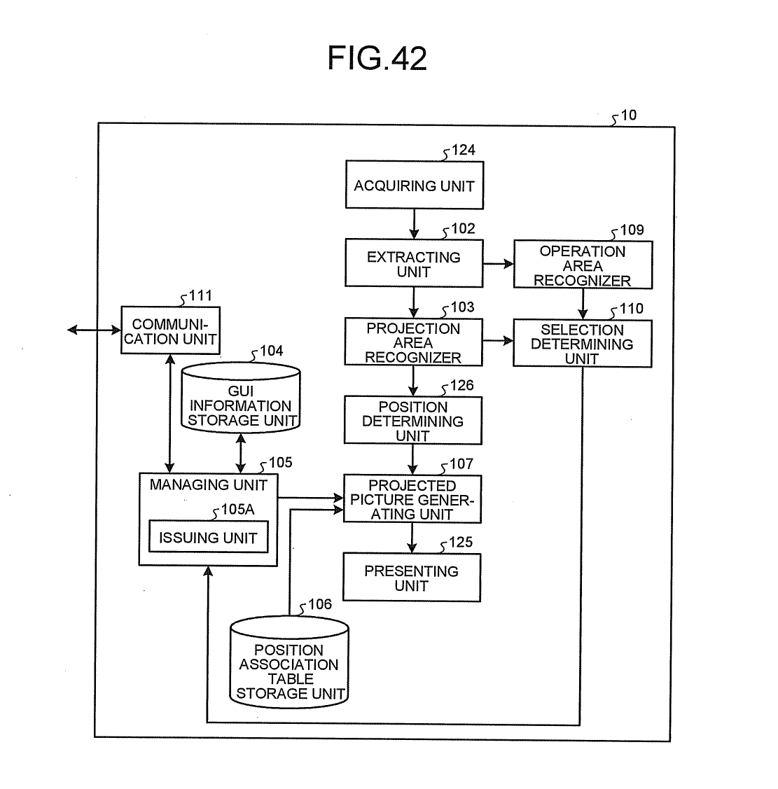

FIG. 42 is a configuration diagram illustrating an example of the command issuing device 10 according to the fifth embodiment. The fifth embodiment differs from the first embodiment in that the command issuing device 10 further includes the acquiring unit 124, the presenting unit 125 and a position determining unit 126.

The acquiring unit 124 is worn on the head of the operator 21 and captures the hand 22 of the operator 21 as a moving image.

The presenting unit 125 presents a picture generated by the projected picture generating unit 107 onto the eyewear type display device that the operator 21 wears on his/her head.

The position determining unit 126 determines the presenting position of the picture to be presented on a presentation finger recognized by the projection area recognizer 103.

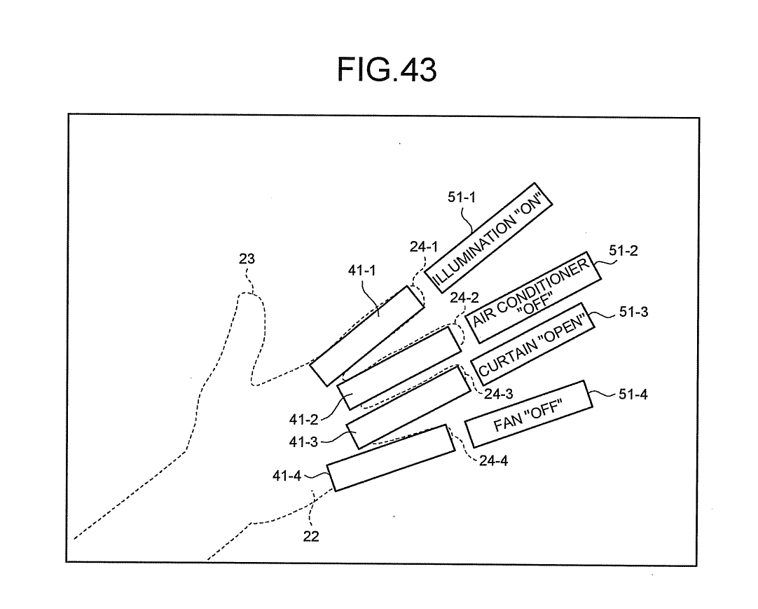

In the fifth embodiment, since the presenting unit 125 is an eyewear type display that the operator 21 wears on his/her head, the presentation area of pictures is not limited to the surface of an object such as the hand 22 that actually exists. The presenting unit 125 can therefore separate a region for presenting a GUI picture from a region for determining the overlap with the operation finger, and present the GUI picture at a position beside the tip of the presentation finger as illustrated in FIG. 43. In order to perform projection of GUI pictures in this manner, the position determining unit 126 extrapolates the position of the presentation area calculated by the projection area recognizer 103 in a direction away from the tip of the presentation finger and outputs the position, as a preprocess before the process performed by the projected picture generating unit 107.

Although the command issuing device 10 worn by the operator 21 on his/her head is described in the fifth embodiment, a command issuing device can also be realized by a personal digital assistant by displaying a moving image captured by the acquiring unit 124 on a display that is the presenting unit 125 and superimposing a GUI at the picture position on the hand captured by the acquiring unit 124 on the moving image.

The command issuing devices according to the embodiments and the modified examples described above each include a controller such as a central processing unit (CPU), a storage unit such as a ROM and a RAM, an external storage device such as a HDD and a SSD, a display device such as a display, an input device such as a mouse and a keyboard, and a communication device such as a communication interface, which is a hardware configuration utilizing a common computer system.

Programs to be executed by the command issuing devices according to the embodiments and the modified examples described above are recorded on a computer readable recording medium such as a CD-ROM, a CD-R, a memory card, a DVD and a flexible disk (FD) in a form of a file that can be installed or executed, and provided therefrom.

Alternatively, the programs to be executed by the command issuing devices according to the embodiments and the modified examples described above may be stored on a computer system connected to a network such as the Internet, and provided by being downloaded via the network. Alternatively, the programs to be executed by the command issuing devices according to the embodiments and the modified examples described above may be provided or distributed through a network such as the Internet. Still alternatively, the programs to be executed by the command issuing devices according to the embodiments and the modified examples may be embedded on a ROM or the like in advance and provided therefrom.

The programs to be executed by the command issuing devices according to the embodiments and the modified examples described above have modular structures for implementing the units described above on a computer system. In an actual hardware configuration, a CPU reads the programs from a HDD and executes the programs, for example, whereby the respective units described above are implemented on a computer system.

As described above, according to the embodiment and the modification examples described above, it is possible to complete the user operation by using one hand.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A command issuing device comprising:
an acquiring unit configured to acquire a moving image by capturing a hand of an operator;
a projection area recognizer configured to recognize a projection area of a projection finger in the moving image, the projection finger being one of fingers onto which one of pictures of a graphical user interface (GUI) is projected;
a projector configured to project one of the pictures of the GUI onto the projection area;
an operation area recognizer configured to recognize an operation area of an operation finger in the moving image, the operation finger being one of fingers which is assigned to operate the GUI;
a selection determining unit configured to measure an overlapping degree of the projection area and the operation area to determine whether or not the GUI is selected; and
a issuing unit configured to issue a command associated with the GUI when it is determined that the GUI is selected.

2. The device according to claim 1, wherein the projection area has a plurality of sub projection areas, and the projector projects a plurality of GUI pictures onto the sub projection areas.

3. The device according to claim 1, wherein the projection area is an area represented by a shape feature value of the projection finger.

4. The device according to claim 1, further comprising:
a switching determining unit configured to determine whether to switch the picture of GUI projected on the projection area on the basis of a posture of the hand; and
a switch configured to switch the GUI to be projected onto the projection area, wherein
the projector projects a picture of GUI resulting from switching onto the projection area.

5. The device according to claim 1, wherein the projector projects a feedback picture for the picture of GUI projected on the projection area with which the operation area overlaps onto any area of the hand.

6. The device according to claim 1, further comprising an assignment determining unit configured to determine assignment of GUIs to the projection area, wherein
the projector projects the picture of GUI onto the projection area according to the determined assignment.

7. A command issuing device comprising:
an acquiring unit configured to acquire a moving image by capturing a hand of an operator;
a projection area recognizer configured to recognize a projection area of a projection finger in the moving image, the projection finger being one of fingers onto which one of pictures of a graphical user interface (GUI) is projected;
a projector configured to project one of the pictures of the GUI onto the projection area;
a selection determining unit configured to measure a bending degree of the projection finger to determine whether or not the GUI is selected; and
a issuing unit configured to issue a command associated with the GUI when it is determined that the GUI is selected.

8. The device according to claim 7, wherein the projection area is an area represented by a shape feature value of the projection finger.

9. The device according to claim 7, further comprising:
a switching determining unit configured to determine whether to switch the picture of GUI projected on the projection area on the basis of a posture of the hand; and
a switch configured to switch the GUI to be projected onto the projection area, wherein
the projector projects a picture of GUI resulting from switching onto the projection area.

10. The device according to claim 7, wherein the projector projects a feedback picture for the picture of GUI projected on the projection area with which the operation area overlaps onto any area of the hand.

11. The device according to claim 7, further comprising an assignment determining unit configured to determine assignment of GUIs to the projection area, wherein
the projector projects the picture of GUI onto the projection area according to the determined assignment.

12. A command issuing method comprising:
acquiring a moving image by capturing a hand of an operator;
recognizing a projection area of a projection finger in the moving image, the projection finger being one of fingers onto which one of pictures of a graphical user interface (GUI) is projected;
projecting one of the pictures of the GUI onto the projection area;
recognizing an operation area of an operation finger in the moving image, the operation finger being one of fingers which is assigned to operate the GUI;
measuring an overlapping degree of the projection area and the operation area to determine whether or not the GUI is selected; and
issuing a command associated with the GUI when it is determined that the GUI is selected.

13. A command issuing method comprising:
acquiring a moving image by capturing a hand of an operator;
recognizing a projection area of a projection finger in the moving image, the projection finger being one of fingers onto which one of pictures of a graphical user interface (GUI) is projected;
projecting one of the pictures of the GUI onto the projection area;
measuring a bending degree of the projection finger to determine whether or not the GUI is selected; and
issuing a command associated with the GUI when it is determined that the GUI is selected.

14. A computer program product comprising a computer-readable medium including program instructions, wherein the instructions, when executed by a computer, cause the computer to execute:
acquiring a moving image by capturing a hand of an operator;
recognizing a projection area of a projection finger in the moving image, the projection finger being one of fingers onto which one of pictures of a graphical user interface (GUI) is projected;
projecting one of the pictures of the GUI onto the projection area;
recognizing an operation area of an operation finger in the moving image, the operation finger being one of fingers which is assigned to operate the GUI;
measuring an overlapping degree of the projection area and the operation area to determine whether or not the GUI is selected; and
issuing a command associated with the GUI when it is determined that the GUI is selected.

15. A computer program product comprising a computer-readable medium including program instructions, wherein the instructions, when executed by a computer, cause the computer to execute:
acquiring a moving image by capturing a hand of an operator;
recognizing a projection area of a projection finger in the moving image, the projection finger being one of fingers onto which one of pictures of a graphical user interface (GUI) is projected;
projecting one of the pictures of the GUI onto the projection area;
measuring a bending degree of the projection finger to determine whether or not the GUI is selected; and
issuing a command associated with the GUI when it is determined that the GUI is selected.
